(19) United States
(12) Patent Application Publication
(10) Pub. No.: US 2006/0090298 A1
(43) Pub. Date: May 4, 2006

(54) Hinge device

(76) Inventor: Yoshiharu Kitamura, Nagano (JP)

Correspondence Address: MCGLEW & TUTTLE, PC, P.O. BOX 9227, SCARBOROUGH STATION, SCARBOROUGH, NY, 10510-9227, US

(21) Appl. No.: 10/528,199

(22) PCT Filed: Sep. 17, 2003
(86) PCT No.: PCT/JP03/11814

§ 371 Date: Sep. 20, 2005

(30) Foreign Application Priority Data
Sep. 17, 2002 (JP) 2002-269938

(51) Int. Cl. E05D 11/08

(52) U.S. Cl. 16/337

(57) ABSTRACT

Disclosed is a hinge device for openably and closably connecting one member and the other member, including: a base member fixed to the one member; a movable shaft that is rotatably supported by the base member and to which the other member is fixed; a leaf spring member having a curved portion and non-rotatably but axially movably inserted onto the movable shaft; and a fixing plate inserted onto the movable shaft such that the fixing plate does not rotate when the movable shaft rotates but is axially movable, the fixing plate having at least two protrusions provided on its surface in contact with the leaf spring member. The leaf spring member and the fixing plate are pressed into contact with each other for relative rotation therebetween.

### TECHNICAL FIELD

This invention relates to a hinge device for openably and closably connecting two members like a main body and a cover member, for use in small OS devices or portable terminal devices, such as a notebook PC and a portable telephone, and toilet lids.

### BACKGROUND ART

Information devices such as a notebook PC and a portable telephone have a keyboard provided in, for example, a main body thereof and have a display device provided in, for example, a cover member thereof. The cover member provided with the display device is connected to the main body through a hinge device, allowing the cover member to be opened/closed, stopped in position, and held at an angle for easy viewing.

Conventionally, as disclosed in JP 10-252739 A, JP 11-44142 A, and the like, generally employed as such a hinge device is one having a pair of cams whose axes are in alignment with each other and which are capable of rotating relative to and moving toward and away from each other, with the respective cam surfaces of those cams being urged by a spring into intimate contact with each other; as the two cams rotate relative to each other, the two cams move relative to each other along their axes, thereby changing the angular relationship between the two cams.

Although the above-described conventional hinge device proves satisfactory in proving such functions as opening/closing, stopping, and holding the display device (cover member), the conventional hinge device involves such problems as requiring a large number of parts and a complicated structure. For this reason, the manufacture of such a conventional hinge device is somewhat troublesome and involves a high manufacturing cost, resulting in cost increases. Further, a cam member and a slide cam member (the two cams mentioned above) are provided with cam portions that come into engagement with each other, and this construction places a limitation in reducing (miniaturizing) the axial size (length).

The present invention has been made in view of the above problems and therefore it is an object of the invention to provide a hinge device of a simple construction which requires only a small number of parts, is easy to assemble, allows reductions in weight and size, and is capable of producing a requisite torque or clicking sensation even when miniaturized, while being inexpensive.

### DISCLOSURE OF THE INVENTION

A hinge device of the present invention relates to a hinge device for openably and closably connecting one member and the other member, including: a base member fixed to the one member; a movable shaft that is rotatably supported by the base member and to which the other member is fixed; a leaf spring member having a curved portion and non-rotatably but axially movably inserted onto the movable shaft; and a fixing plate inserted onto the movable shaft such that the fixing plate does not rotate when the movable shaft rotates but is axially movable, the fixing plate having at least two protrusions provided on its surface in contact with the leaf spring member, in which the leaf spring member and the fixing plate are pressed into contact with each other for relative rotation therebetween.

Accordingly, when the base member is fixed to the one member, and the other member is fixed to the movable shaft, the movable shaft rotates as the other member is opened and closed. Since the leaf spring member is non-rotatably but axially movably inserted onto the movable shaft, the leaf spring member thus rotates together with the movable shaft at this time. Although axially movable, the fixing plate does not rotate even when the movable shaft rotates. The leaf spring member and the fixing plate are pressed into contact with each other, whereby rotation of the leaf spring member accompanying the rotation of the movable shaft causes the leaf spring member and the fixing plate to relatively rotate while in press contact with each other. Accordingly, in the rotation position where the curved portion of the leaf spring member overlaps the protrusion on the fixing plate, the leaf spring member is compressed and thus its urging force increases at the contact position with the protrusion on the fixing plate, resulting in an increased rotation torque; conversely, in the rotation position where the curved portion of the leaf spring member and the protrusion of the fixing plate are shifted from each other, the urging force of the leaf spring member decreases, resulting in a reduced rotation torque. Such a change in rotation torque can be used in controlling the opening and closing of the one member and the other member. Further, this change in rotation torque becomes a smooth one due to the configuration of the curved portion of the leaf spring member.

Further, a hinge device of the present invention relates to a hinge device for openably and closably connecting one member and the other member, including: a base member fixed to the one member; a movable shaft that is rotatably supported by the base member and to which the other member is fixed; a leaf spring member having a curved portion and inserted onto the movable shaft such that the leaf spring member does not rotate when the movable shaft rotates but is axially movable; and a fixing plate non-rotatably but axially movably inserted onto the movable shaft, the fixing plate having at least two protrusions provided on its surface in contact with the leaf spring member, in which the fixing plate and the leaf spring member are pressed into contact with each other for relative rotation therebetween.

Accordingly, when the base member is fixed to the one member, and the other member is fixed to the movable shaft, the movable shaft rotates as the other member is opened and closed. Since the fixing plate is non-rotatably but axially movably inserted onto the movable shaft, the fixing plate thus rotates together with the movable shaft at this time. Although axially movable, the leaf spring member does not rotate even when the movable shaft rotates. The fixing plate and the leaf spring member are pressed into contact with each other, whereby rotation of the fixing plate accompanying the rotation of the movable shaft causes the fixing plate and the leaf spring member to relatively rotate while in press contact with each other. Accordingly, in the rotation position where the protrusion on the fixing plate overlaps the curved portion of the leaf spring member, the leaf spring member is compressed and thus its urging force increases at the contact position with the protrusion of the fixing plate, resulting in an increased rotation torque; conversely, in the rotation position where the protrusion of the fixing plate and the curved portion of the leaf spring member are shifted from each other, the urging force of the leaf spring member decreases, resulting in a reduced rotation torque. Such a change in rotation torque can be used in controlling the opening and closing of the one member and the other member. Further, this change in rotation torque becomes a smooth one due to the configuration of the curved portion of the leaf spring member.

Further, in the hinge device of the present invention, the base member is a bottomed hollow cylindrical case, and the movable shaft onto which the leaf spring member and the fixing plate are inserted is rotatably supported by the case, with the leaf spring member and the fixing plate being received within the case.

Accordingly, the mechanism portions such as the leaf spring member and the fixing plate are received within the case, whereby those components are protected without being exposed to the exterior. In addition, a compact construction and easy assembly can be realized.

Further, in the hinge device of the present invention, the base member is a hollow cylindrical case that is open at both ends, and the movable shaft onto which the leaf spring member and the fixing plate are inserted is rotatably supported while penetrating through the case, with the leaf spring member and the fixing plate being received within the case.

Accordingly, the mechanism portions such as the leaf spring member and the fixing plate are received within the case, whereby those components are protected without being exposed to the exterior. Further, a compact construction is realized, and the assembly of parts is facilitated since the movable shaft penetrates through the case.

Further, in the hinge device of the present invention, one of the leaf spring member and the fixing plate is provided with a protrusion and the other is provided with a recess, hole, or cutout into which the protrusion falls, and a clicking sensation is produced when the protrusion provided in one of the two components fits in the recess, hole, or cutout provided in the other as the leaf spring member and the fixing plate relatively rotate while in press contact with each other.

Accordingly, a clicking sensation can be produced at a predetermined position during the opening/closing operation.

Further, a hinge device of the present invention relates to a hinge device for openably and closably connecting one member and the other member, including: a bracket fixed to the one member; a movable shaft that is rotatably supported by the bracket and to which the other member is fixed; and a leaf spring member having a curved portion and non-rotatably but axially movably inserted onto the movable shaft, characterized in that the bracket has at least two protrusions provided on its surface in contact with the leaf spring member, and that the leaf spring member and the bracket are pressed into contact with each other for relative rotation therebetween.

Accordingly, the bracket also serves as the fixing plate, whereby the fixing plate as described above can be omitted to achieve a reduction in the number of parts. Further, being a bracket, it is more readily applicable to the opening and closing device used.

Further, in the hinge device of the present invention, one of the leaf spring member and the bracket is provided with a protrusion and the other is provided with a recess, hole, or cutout into which the protrusion falls, and a clicking sensation is produced when the protrusion provided in the one of the two components fits in the recess, hole, or cutout provided in the other as the leaf spring member and the bracket relatively rotate while in press contact with each other.

Accordingly, the above hinge device can also produce a clicking sensation at a predetermined position during the opening/closing operation.

Further, a hinge device of the present invention relates to a hinge device for openably and closably connecting one member and the other member, including: a movable shaft; a first bracket non-rotatably and fixedly installed on the movable shaft and fixed to the one member; a second bracket rotatably and axially movably inserted onto the movable shaft and fixed to the other member; a fixing plate secured onto the second bracket while having the movable shaft inserted through the fixing plate; and a leaf spring member having a curved portion and non-rotatably but axially movably inserted onto the movable shaft, characterized in that at least two protrusions are provided on a contact surface of one of the fixing plate and the leaf spring member, and that the fixing plate and the leaf spring member are pressed into contact with each other for relative rotation therebetween.

Accordingly, in addition to providing the rotation torque characteristics as described above, this construction allows the mounting to the one member and the other member to be effected with the brackets (the first bracket and the second bracket). The hinge device of the above construction is thus optimum for application to devices for which mounting with brackets is preferred.

Further, in the hinge device of the present invention, one of the leaf spring member and the fixing plate that is secured onto the second bracket is provided with a protrusion and the other is provided with a recess, hole, or cutout into which the protrusion falls, and that a clicking sensation is produced when the protrusion provided in the one of the two components fits in the recess, hole, or cutout provided in the other as the leaf spring member and the fixing plate relatively rotate while in press contact with each other.

Accordingly, the above hinge device can also produce a clicking sensation at a predetermined position during the opening/closing operation.

Further, the hinge device of the present invention is characterized in that: the movable shaft has a flange portion provided at a midway position thereof; a friction plate is non-rotatably but axially movably inserted onto the movable shaft while in contact with the flange portion of the movable shaft; a reinforcing plate is secured, while being inserted onto the movable shaft, onto a side surface of the second bracket which is opposite to a side surface onto which the fixing plate is secured; and the friction plate and the reinforcing plate are pressed into contact with each other for relative rotation therebetween.

Accordingly, a friction force can be generated between the friction plate and the reinforcing plate as they rotate, whereby during the opening/closing of the two members, this friction force can be added to the rotation torque described above in controlling the opening and closing of the one member and the other member.

Further, the hinge device of this invention is characterized in that a reinforcing leaf spring member is laminated on the leaf spring member.

This construction allows the spring force of the leaf spring member to be increased and decreased, making it possible to adjust the friction force with which the leaf spring member and the fixing plate are held in sliding contact with each other.

Further, the hinge device of this invention is characterized in that the leaf spring member and the reinforcing leaf spring member laminated on each other differ in spring force.

Further, the hinge device of this invention is characterized in that the leaf spring member and the reinforcing leaf spring member laminated on each other differ in deflection amount.

The above constructions allow the reinforcing leaf spring member and the leaf spring member to be used as appropriate to serve different purposes (for example, to function like a laminated spring) such that the reinforcing leaf spring member is used for portions where deflection is required and the leaf spring member is used for portions where a torque is required.

Further, the hinge device of this invention is characterized in that the protrusion is a ball.

Although implemented as a ball, the above ball serves as a protrusion in the contact surface with the leaf spring member, thus acting in the same manner as the above-mentioned protrusion.

With the hinge device of the present invention as described above, the rotation torque to be generated can be freely changed (adjusted) by changing the position and configuration of the protrusions on the fixing plate and the configuration of the curved portion of the leaf spring member. Moreover, the rotation torque to be generated can be increased by arranging the combination of the fixing plate and the leaf spring member in multiple stages. Further, such a multi-staged (multi-layered) construction does not lead to a large increase in size.

The hinge device of the present invention provides the following effects.

(1) The leaf spring member, e.g. a spring washer doubles as a spring and two cam members used in the prior art, whereby one of the cam members becomes unnecessary, realizing a corresponding reduction in the number of parts and a simplified construction.

(2) The simplified construction involving a reduced number of parts makes the assembly easier and less troublesome, enabling a high-precision assembly process as well as an improvement in quality.

(3) The simple structure facilitates manufacture, and the reduced number of parts allows a reduction in overall cost.

(4) The simple structure involving a reduced number of parts, the main portion of which consists of plate members, enables reductions in weight and size. In addition, the laminated structure of the plate members allows torque amplification to be achieved without involving a large increase in size.

(5) The load characteristics and rotation torque can be arbitrarily set, whereby the hinge device can be used not only as a hinge device for an opening and closing member but for a wide variety of applications as a hinge device for which various balance characteristics and the like are required.

(6) A smooth rotation torque change can be realized due to the configuration of the curved portion of the leaf spring member.

It is to be noted that the phrase “the rotation position where the protrusion on the fixing plate overlaps the curved portion of the leaf spring member” as used herein refers to the rotation position where the protrusion overlaps the convex side of the curved portion.

### BRIEF DESCRIPTION OF THE DRAWINGS

FIGS. 1 show a hinge device according to a first embodiment of the present invention, of which FIG. 1(a) is a front view, FIG. 1(b) is a left-hand side view, and FIG. 1(c) is a right-hand side view, and FIG. 2 is an enlarged sectional view taken along the line A-A of FIG. 1(c).

FIGS. 3 show a movable shaft, of which FIG. 3(a) is a plan view thereof, FIG. 3(b) is a front view thereof, and FIG. 3(c) is a side view thereof; FIGS. 4 show a spring washer as a leaf spring member, of which FIG. 4(a) is a side view thereof, FIG. 4(b) is a front view thereof, and FIG. 4(c) is a perspective view thereof; FIGS. 5 show a fixing plate, of which FIG. 5(a) is a front view thereof, and FIG. 5(b) is an enlarged sectional view taken along the line B-B of FIG. 5(a); FIGS. 6 show a presser washer, of which FIG. 6(a) is a side view thereof, and FIG. 6(b) is a front view thereof; and FIGS. 7 show a case, of which FIG. 7(a) is a front view thereof, FIG. 7(b) is a left-hand side view thereof, FIG. 7(c) is an enlarged right-hand side view thereof, and FIG. 7(d) is a sectional view taken along the line C-C of FIG. 7(c).

FIGS. 8 show a fixing plate for explaining rotation torque characteristics, of which FIG. 8(a) is an enlarged front view thereof, and FIG. 8(b) is a longitudinal central sectional view thereof, and FIG. 9 is a graph illustrating rotation torque characteristics in the case where the fixing plate of the first embodiment is constructed as shown in FIGS. 8.

FIGS. 10 show a fixing plate for explaining rotation torque characteristics, of which FIG. 10(a) is an enlarged front view thereof, and FIG. 10(b) is a longitudinal central sectional view thereof, and FIG. 11 is a graph illustrating rotation torque characteristics in the case where the fixing plate of the first embodiment is constructed as shown in FIGS. 10.

FIGS. 12 show a fixing plate for explaining rotation torque characteristics, of which FIG. 12(a) is an enlarged front view thereof, and FIG. 12(b) is a longitudinal central sectional view thereof, and FIG. 13 is a graph illustrating rotation torque characteristics in the case where the fixing plate of the first embodiment is constructed as shown in FIGS. 12.

FIG. 14 is an enlarged sectional view showing a second embodiment of the present invention, FIG. 15 is an enlarged sectional view showing a third embodiment of the present invention, FIG. 16 is an enlarged sectional view showing a fourth embodiment of the present invention, FIG. 17 is an enlarged sectional view showing a fifth embodiment of the present invention, and FIG. 18 is an enlarged sectional view showing a sixth embodiment of the present invention.

FIGS. 19 show another example of a fixing plate, of which FIG. 19(a) is a front view thereof, and FIG. 19(b) is an enlarged sectional view taken along the line D-D of FIG. 19(a); and FIGS. 20 show still another example of a fixing plate, of which FIG. 20(a) is a front view thereof, and FIG. 20(b) is an enlarged sectional view taken along the line E-E of FIG. 20(a).

FIG. 21 is an enlarged sectional view showing a seventh embodiment of the present invention.

FIG. 22 is an enlarged, exploded perspective view showing an eighth embodiment of the present invention, and FIG. 23 is an enlarged sectional view showing the eighth embodiment of the present invention.

FIG. 24 is an enlarged, exploded perspective view showing a ninth embodiment of the present invention, and FIG. 25 is an enlarged sectional view showing the ninth embodiment of the present invention.

FIG. 26 is an enlarged, exploded perspective view showing a tenth embodiment of the present invention, and FIG. 27 is an enlarged sectional view showing the tenth embodiment of the present invention.

FIG. 28 is an enlarged perspective view showing an eleventh embodiment of the present invention, FIG. 29 is an enlarged front view showing the eleventh embodiment of the present invention, FIG. 30 is an enlarged, exploded perspective view showing the eleventh embodiment of the present invention, and FIG. 31 is a perspective view of a second bracket as seen from the side opposite to that of FIG. 30.

FIGS. 32 show another modification of a spring washer, of which FIG. 32(a) is an enlarged side view thereof, FIG. 32(b) is an enlarged front view thereof, and FIG. 32(c) is an enlarged perspective view thereof.

FIGS. 33 show a fixing plate according to the eleventh embodiment, of which FIG. 33(a) is an enlarged side view thereof, FIG. 33(b) is an enlarged front view thereof, and FIG. 33(c) is an enlarged perspective view thereof; FIGS. 34 show a spring washer as a leaf spring member according to the eleventh embodiment, of which FIG. 34(a) is an enlarged side view thereof, FIG. 34(b) is an enlarged front view thereof, and FIG. 34(c) is an enlarged perspective view thereof; and FIGS. 35 show a modification of a spring washer, of which FIG. 35(a) is an enlarged side view thereof, FIG. 35(b) is an enlarged front view thereof, and FIG. 35(c) is an enlarged perspective view thereof.

FIGS. 36 show a modification of a fixing plate, of which FIG. 36(a) is an enlarged side view thereof, FIG. 36(b) is an enlarged front view thereof, and FIG. 36(c) is an enlarged perspective view thereof.

FIG. 37 is an enlarged front view showing a twelfth embodiment of the present invention, and FIG. 38 is an enlarged, exploded perspective view showing the twelfth embodiment of the present invention.

FIG. 39 is an enlarged front view showing a thirteenth embodiment of the present invention, and FIG. 40 is an enlarged, exploded perspective view showing the thirteenth embodiment of the present invention.

FIG. 41 is an enlarged front view showing a fourteenth embodiment of the present invention, and FIG. 42 is an enlarged, exploded perspective view showing the fourteenth embodiment of the present invention.

### BEST MODE FOR CARRYING OUT THE INVENTION

The present invention is now described in more detail with reference to the accompanying drawings.

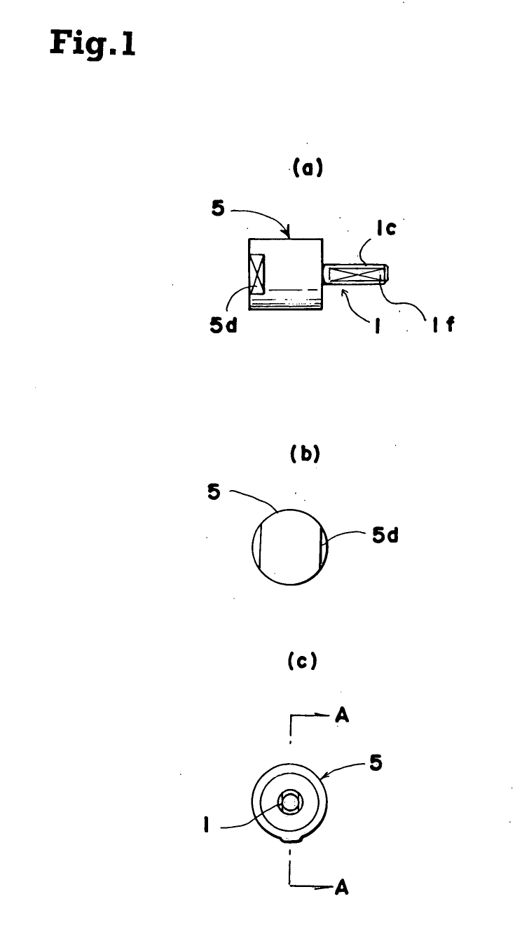

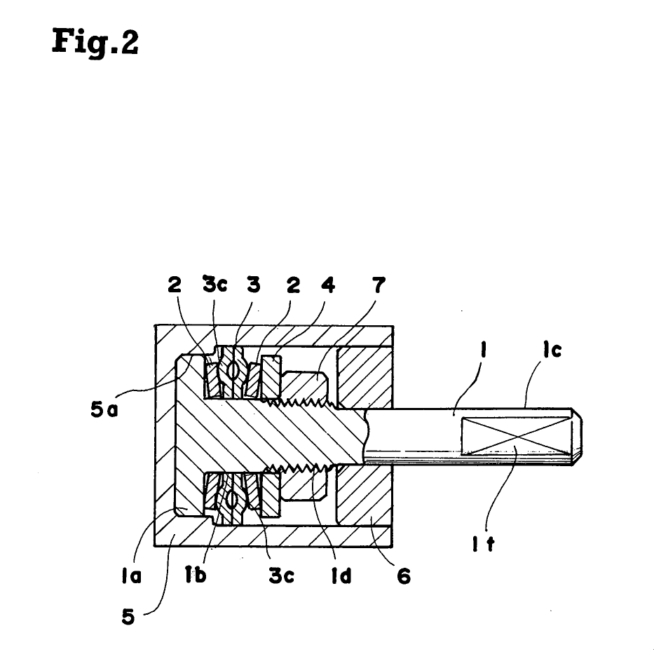

FIGS. 1 show a hinge device according to a first embodiment of the present invention, of which FIG. 1(a) is a front view, FIG. 1(b) is a left-hand side view, and FIG. 1(c) is a right-hand side view, and FIG. 2 is an enlarged sectional view taken along the line A-A of FIG. 1(c).

This hinge device is composed of: a case 5 as a base member fixed to one member, for example, a main body; a movable shaft 1 rotatably mounted to the case 5 and to which the other member, for example, a cover member, is fixed; spring washers 2 each serving as a leaf spring member to be inserted onto the movable shaft 1 so as to be axially movable while having its rotation restricted (prohibited); and fixing plates 3 held in contact with the spring washers 2 and rotatably and axially movably inserted onto the movable shaft 1 while having their rotation restricted by the case 5. The spring washers 2 and the fixing plates 3 are held in press contact with each other while having their axial movement regulated by a presser washer 4 and a nut 7 serving as regulating members.

The spring washer 2 serving as a leaf spring member is inserted onto the movable shaft 1 so as to be axially movable while having its rotation restricted (prohibited), whereby the spring washer 2 rotates together with the movable shaft 1 and is capable of axial movement.

Further, the fixing plate 3 is rotatably and axially movably inserted onto the movable shaft 1 and has its rotation restricted by the case 5, whereby the fixing plate 3 does not rotate even when the movable shaft 1 rotates while still being capable of axial movement.

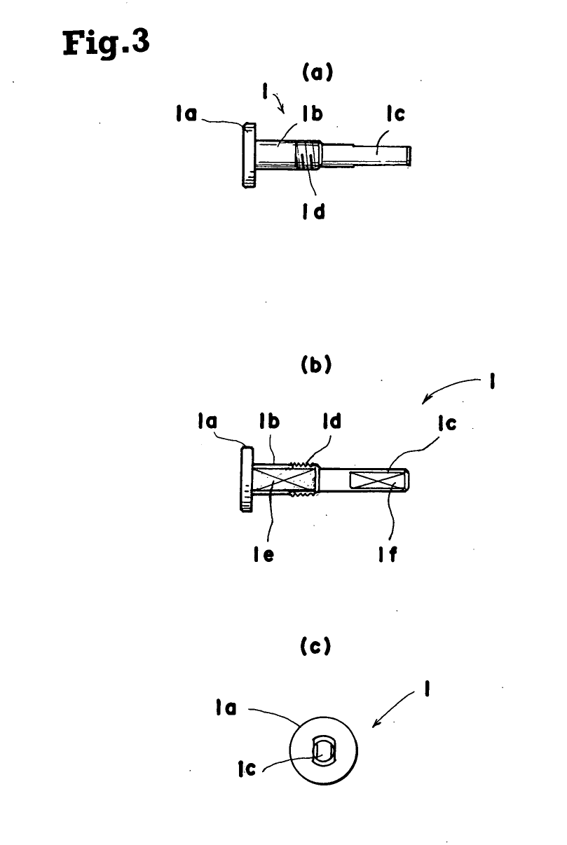

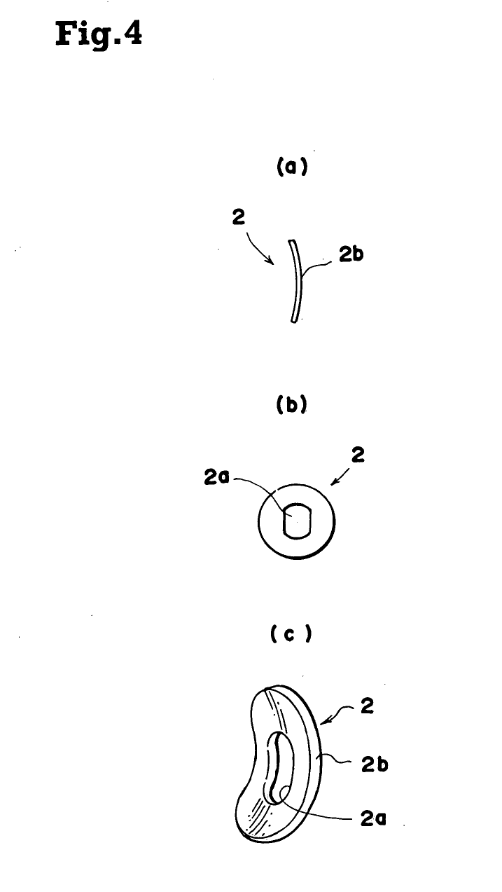

Further detailed description is given below. First, FIG. 3 shows the movable shaft 1. FIGS. 3 show the movable shaft, of which FIG. 3(a) is a plan view, FIG. 3(b) is a front view, and FIG. 3(c) is a side view thereof. The movable shaft 1 is composed of a flange portion 1a, a main shaft portion 1b, and a support shaft portion 1c. The main shaft portion 1b is composed of a non-circular cross section portion 1e and a threaded portion 1d provided in one end portion of the non-circular cross section portion 1e. The support shaft portion 1c is also provided with a non-circular cross section portion 1f. The other member, for example, a cover member is fixed non-rotatably to the non-circular cross section portion 1f of the support shaft portion 1c. The non-circular cross section portions 1e, 1f, of the main shaft portion 1b and the support shaft portion 1c have a W-D configuration in this example.

FIGS. 4 show the spring washer, of which FIG. 4(a) is a side view, FIG. 4(b) is a front view, and FIG. 4(c) is a perspective view thereof. The spring washer 2, which is formed into a circular configuration using a leaf spring material, has a non-circular hole 2a provided at the center thereof, with a substantially arcuate convex portion 2b (not having a conical configuration) being formed as a curved portion. The non-circular hole 2a is of a W-D configuration in conformity with the non-circular cross section portion 1e of the main shaft portion 1b of the movable shaft 1. The spring washer 2 is non-rotatably but axially movably inserted onto the main shaft portion 1b of the movable shaft 1, and rotates together with the movable shaft 1.

FIGS. 5 show the fixing plate, of which FIG. 5(a) is a front view and FIG. 5(b) is an enlarged sectional view taken along the line B-B of FIG. 5(a). The fixing plate 3 is formed of a plate member, through the center of which the main shaft portion 1b of the movable shaft 1 is inserted. A circular hole 3a that is rotatable with respect to the main shaft portion 1b of the movable shaft 1 is provided in the fixing plate 3 whose outer shape defines a non-circular portion 3b, with protrusions 3c being provided in side surfaces of the fixing plate 3 (its contact surfaces with the spring washer 2). In this example, the non-circular portion 3b has a hexagonal outer shape, and two protrusions 3c are provided at symmetrical positions.

FIGS. 6 show the presser washer, of which FIG. 6(a) is a side view and FIG. 6(b) is a front view thereof. The presser washer 4 consists of a circular plate member and has at the center thereof a non-circular hole 4a having a W-D configuration in conformity with the main shaft portion 1b of the movable shaft 1. The presser washer 4 is inserted onto the main shaft portion 1b of the movable shaft 1 and rotates together with the movable shaft 1.

FIGS. 7 show the case 5, of which FIG. 7(a) is a front view, FIG. 7(b) is a left-hand side view, FIG. 7(c) is an enlarged right-hand side view, and FIG. 7(d) is a sectional view taken along the line C-C of FIG. 7(c). The case 5 has the configuration of a hollow, bottomed cylinder (cup-like configuration). The hollow of the case 5 consists of, from the most bottom side thereof, a circular hole 5a rotatably supporting the flange portion la of the movable shaft 1, a non-circular hole 5b in conformity with the non-circular portion 3b defining the outer shape of the fixing plate 3, and an opening portion serving as a circular hole 5c in which a cover 6 to be described later is fitted. The fixing plate 3 is positioned in the non-circular hole 5b, with the non-circular portion 3b defining its outer shape being in fitting engagement with the non-circular hole 5b, whereby the fixing plate 3 is supported so as to be non-rotatable but axially movable. Further, provided in an outer peripheral end portion of the case 6 is a non-circular portion 5d that is non-rotatably fixed to one member, for example, the main body.

Next, the assembly method for the respective components described above is described. First, the spring washer 2 is inserted onto the main shaft portion 1b of the movable shaft 1, with its convex portion 2b facing the side opposite to the flange portion 1a side. Then, two fixing plates 3 are inserted back-to-back (with the protrusions 3c facing outwardly with respect to each other). The spring washer 2 and then the presser washer 4 are inserted next, the spring washer 2 being orientated such that its convex portion 2b abuts the fixing plate 3. Subsequently, the nut 7 is threadedly engaged with the threaded portion 1d and pressed, thus preventing dislodging from the movable shaft 1.

Next, the above subassembly is inserted into the case 5. At this time, the flange portion 1a of the movable shaft 1 is rotatably supported by the circular hole 5a of the case 5, and the fixing plate 3 is supported by the case 5 so as to be non-rotatable (but free to move in the axial direction) through fitting engagement of the non-circular portion 3b with the non-circular portion 5b of the case 5: the spring washer 2, the pressure washer 4, and the nut 7 rotate together with the movable shaft 1, while the fixing plate 3 does not rotate even when the movable shaft 1 rotates. Finally, the cover 6 is fitted in the circular hole 5c defining the opening portion of the case 5. The cover 6 is provided with a hole through which the support shaft portion 1c of the movable shaft 1 is rotatably inserted, and has an annular outer shape in conformity with the circular hole 5c of the case 5. The cover 6 comes into intimate contact with the circular hole 5c, which defines the opening portion of the case 5, for fitting engagement, thereby sealing the opening of the case 5. In this way, the respective components are assembled onto the hinge device as shown in FIG. 2.

In the hinge device according to the first embodiment as shown in FIG. 2, the case 5 is fixedly installed on one member, for example, a main body through the non-circular portion 5d so as to be non-rotatable, whereas the other member, for example, a cover member is non-rotatably fixed to the non-circular portion 1f of the support shaft portion 1c of the movable shaft 1. Now, when the cover member is opened/closed with respect to the main body, the movable shaft 1 rotates with respect to the case 5, causing the spring washer 2, the presser washer 4, and the nut 7 to also rotate together with the movable shaft 1. The fixing plate 3 does not rotate at this time.

Since the spring washer 2 and the fixing plate 3 are pressed by the nut 7 through the intermediation of the presser washer 4 into surface contact with each other, the above rotation causes the spring washer 2 to rotate while in surface contact with the fixing plate 3. Therefore, in the rotation position where the convex portion 2b of the spring washer 2 overlaps the protrusion 3c of the fixing plate, the spring washer 2 is compressed, whereby the force with which it is urged into contact with the protrusion 3c of the fixing plate increases, leading to an increase in resulting rotation torque.

Conversely, in the rotation position where the convex portion 2b of the spring washer 2 and the protrusion 3c of the fixing plate 3 are shifted from each other, the urging force that acts on the spring washer 2 decreases, leading to a decrease in resulting rotation torque.

In other words, as the spring washer 2 and the fixing plate 3 rotate relative to each other and the relative rotation positions of the convex portion 2b of the spring washer 2 and the protrusion 3c of the fixing plate 3 change, the resulting rotation torque also changes. This change in rotation torque is a smooth one due to the curved configuration of the convex portion 2b of the spring washer 2. The operating feel during opening and closing of two members, for example, during opening and closing of a cover member with respect to a main body, can be set in an arbitrary manner through such a change in rotation torque.

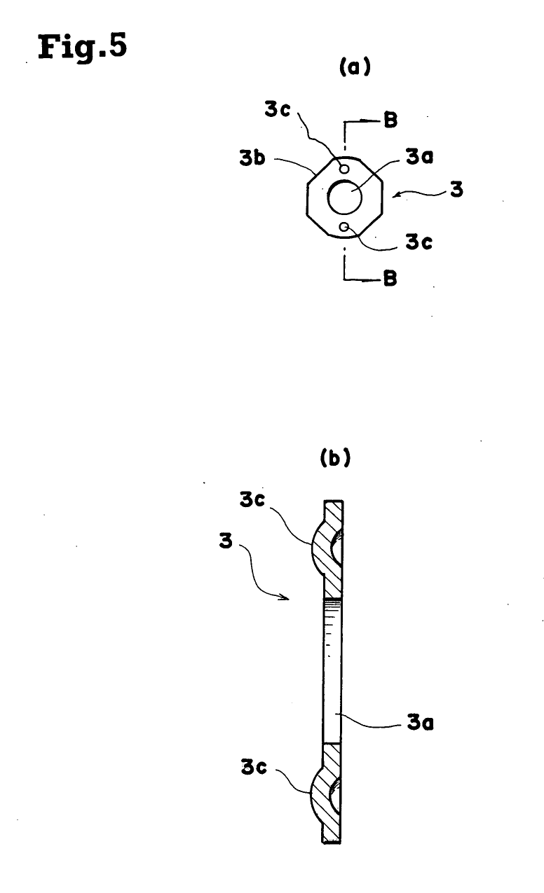

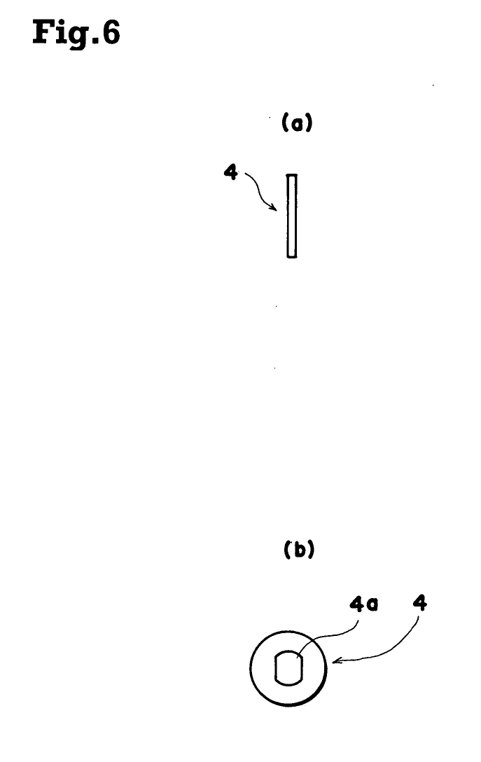

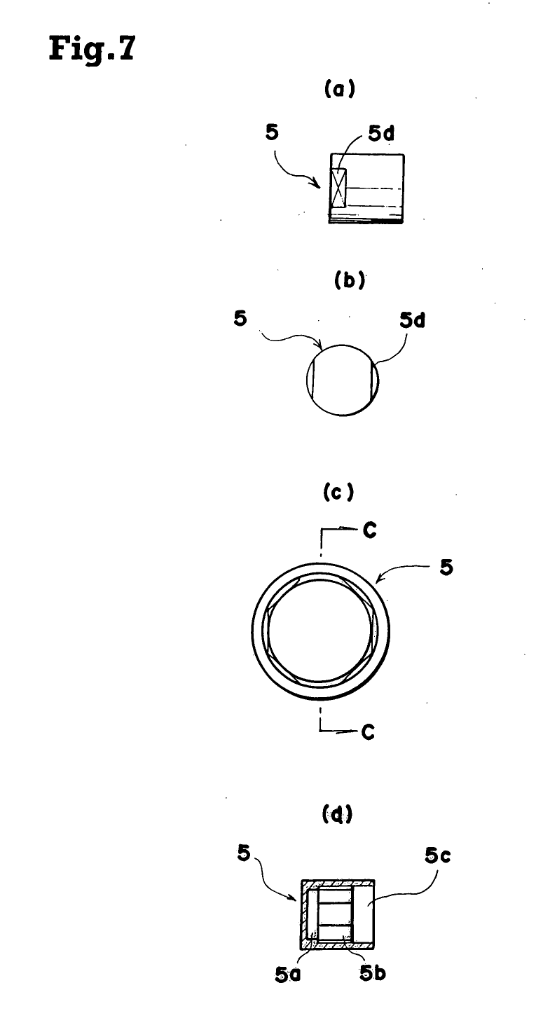

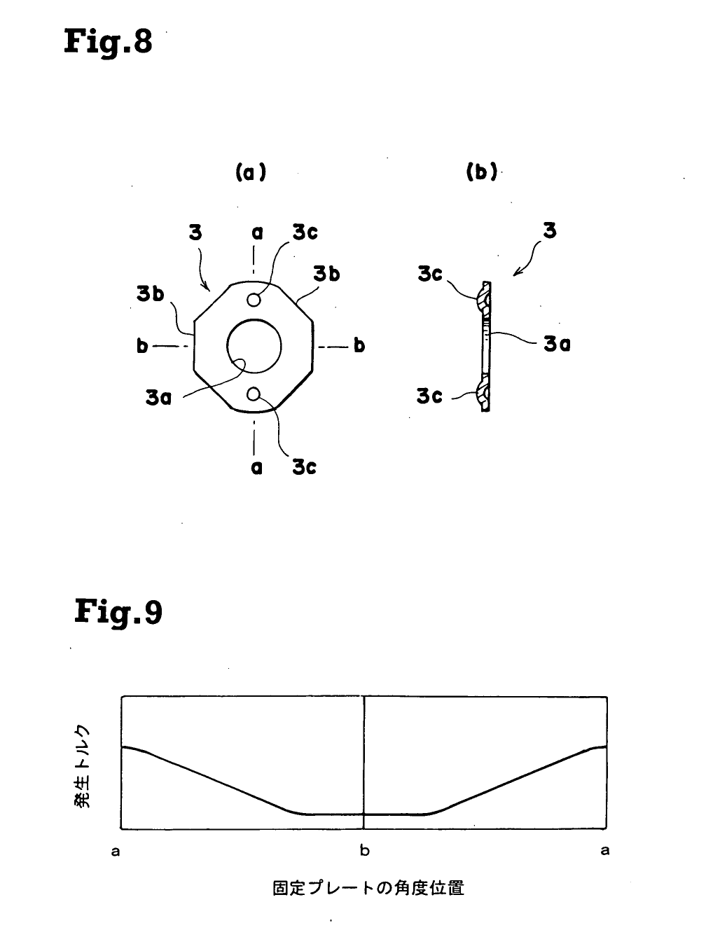

In this embodiment, as illustrated in FIG. 8(a) showing a front view and FIG. 8(b) showing a longitudinal central sectional view thereof, the protrusions 3c of the fixing plate 3 are positioned symmetrical to each other by 180°, with the result that the rotation torque goes through variations in magnitude for each 180° of rotation. Now, as shown in FIG. 8(a), with the position of each protrusion 3c of the fixing plate 3 taken as “a” and with the intermediate point between the protrusions 3c and 3c as “b”, the generated rotation torque becomes as shown in FIG. 9. Accordingly, by generating a torque required at each position, such as generating a large torque in the vicinity of the closing position of the cover member (the point “a” first appearing in FIG. 9) to prevent the cover member from falling, generating a small torque in the vicinity of the upright position (the point “b” of FIG. 9), and generating a large torque in the vicinity of the 180° opened position (the point “a” at the rear of FIG. 9), it is possible to prevent the cover member from falling or to hold it at an arbitrary angle.

The above torque characteristics are optimum when utilized in notebook PCs. That is, while the display device (cover member) is prevented from falling inadvertently in the vicinity of its closing position, only a small holding torque acts on the display device in the vicinity of the upright position, and such a small torque allows improved operating feel during opening and closing of the display device.

As is apparent from the foregoing description, the torque characteristics can be freely changed by changing the arranging positions, configurations, numbers, etc. of the protrusions 3c of the fixing plate 3 and the convex portions 2b of the spring washer 2; for example, the holding angle, operating feel, etc. of the cover member can be freely changed.

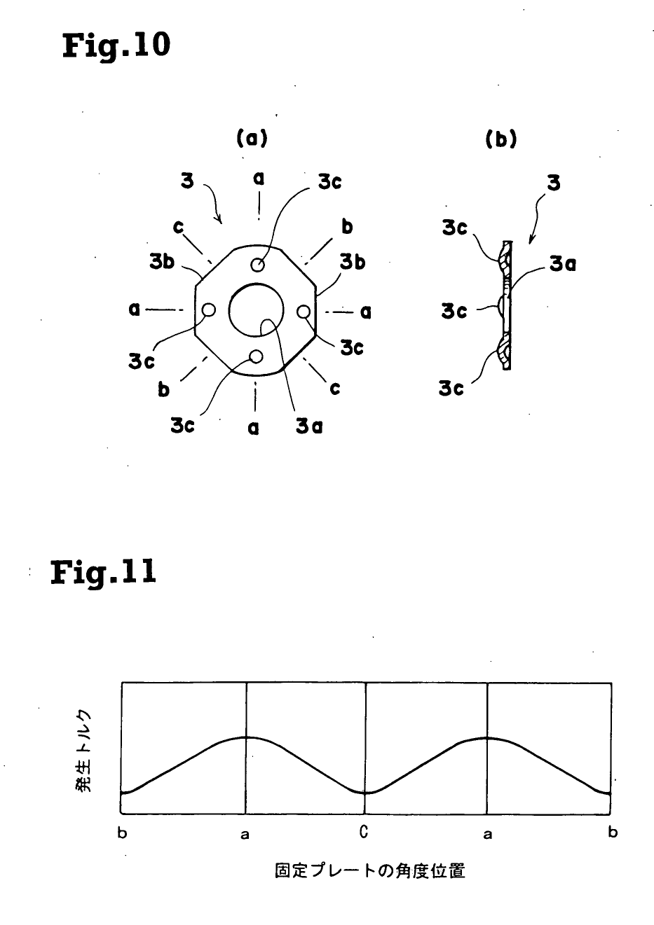

For instance, when, as illustrated in FIG. 10(a) showing an enlarged front view and FIG. 10(b) showing a longitudinal central sectional view thereof, the protrusions 3c of the fixing plate 3 are provided at four positions each separated by 90°, with the positions of each protrusion 3c taken as “a” and the intermediate points between the protrusions 3c and 3c as “b” and “c”, the generated torque becomes as shown in FIG. 11. Accordingly, a requisite torque is generated at each position, such as a small torque in the vicinity of the closing position of the cover member (the point “b” of FIG. 11), a large torque in the vicinity of a slightly opened position (the point “a” of FIG. 11), a small torque in the vicinity of the upright position (the point “c” of FIG. 11), again a large torque in a further opened position (the point “a” of FIG. 11), and a small torque in the vicinity of the 180° opened position (the point “b” of FIG. 11). Thus, the hinge device can keep the cover member in the closed and opened positions by itself (i.e. requires no latch or the like to prevent inadvertent opening and closing) while allowing the cover member to be held at any arbitrary angle in other positions.

Further, the above torque characteristics may be changed such that a requisite torque is generated at each position as follows: a large torque in the vicinity of the closing position of the cover member (the point “a” of FIG. 11): a small torque in a slightly opened position (the point “c” of FIG. 11); and again a large torque in the vicinity of the upright position (the point “a” of FIG. 11). Accordingly, in the closing position of the cover member, braking is applied on the cover member to prevent it from falling, and in the upright position, the cover member can be held in the upright state (i.e. does not close inadvertently), making the obtained torque characteristics suitable for, for example, opening and closing of a toilet lid or the like.

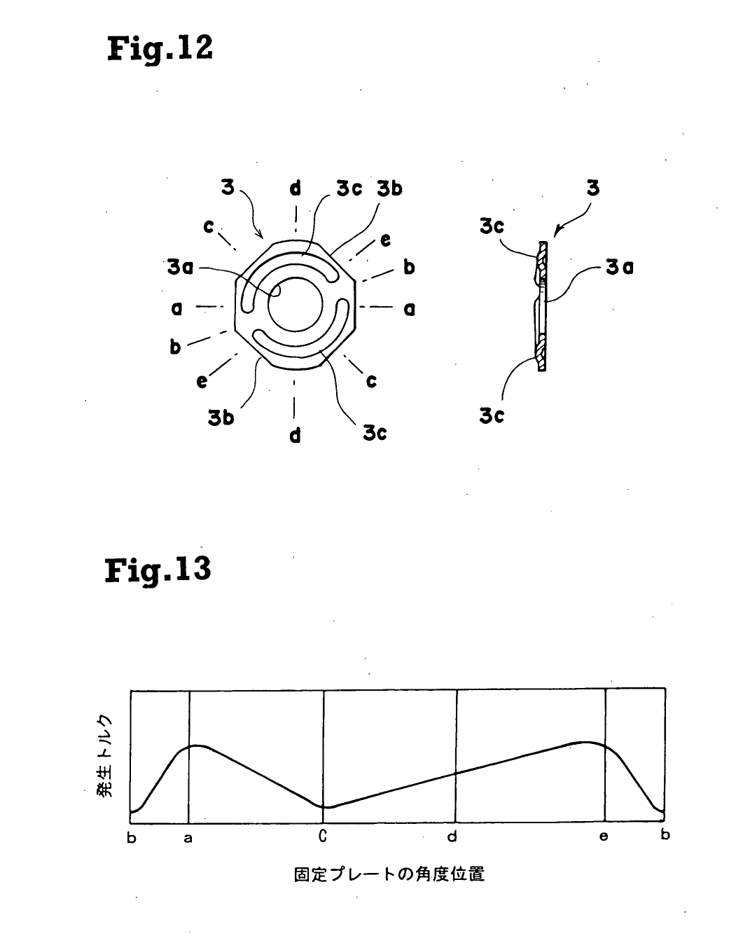

Further, when, as illustrated in FIG. 12(a) showing an enlarged front view and FIG. 12(b) showing a longitudinal central sectional view thereof, the protrusions 3c of the fixing plate 3 are formed as elongated protrusions 3c, the generated torque becomes as shown in FIG. 13. By thus changing the configuration of the protrusions 3c of the fixing plate 3, such as forming the protrusions 3c in an arcuate configuration or varying the height thereof, it is possible to obtain various torque characteristics, that is, to achieve controlled opening and closing.

Further, a clicking sensation can be produced at a predetermined opening/closing position by providing the spring washer 2 with recesses or holes into which the protrusions 3c of the fixing plate 3 fall.

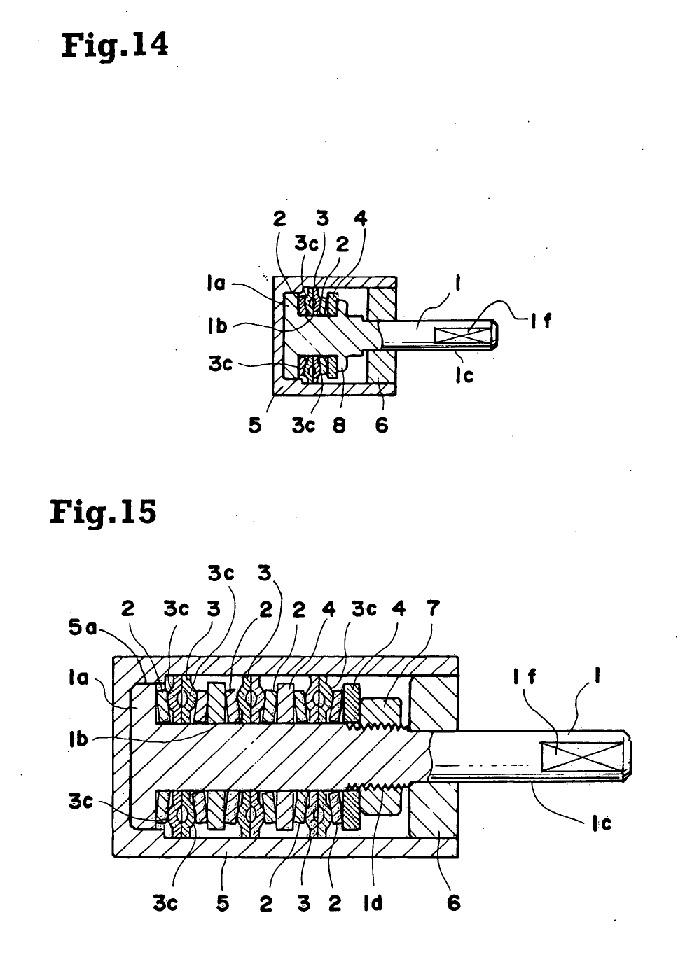

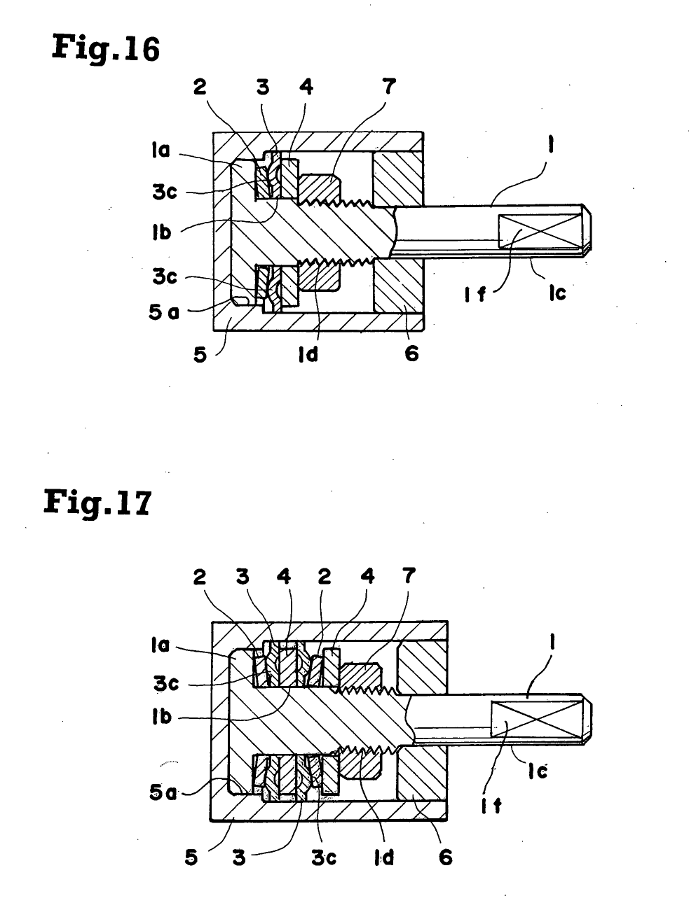

FIG. 14 is an enlarged sectional view showing a second embodiment of the present invention. This embodiment uses a caulking 8 instead of the nut 7 of the first embodiment. Otherwise, this embodiment is the same as the first embodiment, so the same or like components are denoted by the same symbols and detailed description thereof is omitted. In this embodiment as well, the spring washer 2 and the fixing plate 3 are pressed into contact with each other by means of the caulking 8.

FIG. 15 is an enlarged sectional view showing a third embodiment of the present invention. In this embodiment, the combination of the spring washer 2, the fixing plate 3, and the presser washer 4 as described in the first embodiment is provided in multiple (three) stages. Otherwise, this embodiment is the same as the first embodiment, so the same or like components are denoted by the same symbols and detailed description thereof is omitted. An even larger rotation torque can be generated according to this embodiment. Further, the multi-staged construction does not result in a large increase in longitudinal (axial) size because the spring washer 2, the fixing plate 3, and the pressure washer 4 are each formed of a plate member.

FIG. 16 is an enlarged sectional view showing a fourth embodiment of the present invention. In this embodiment, as compared with the first embodiment, one spring washer 2 and one fixing plate 3 are provided, with the presser washer 4 and the fixing plate 3 directly contacting each other. Otherwise, this embodiment is the same as the first embodiment, so the same or like components are denoted by the same symbols and detailed description thereof is omitted. According to this embodiment, the friction force generated between the pressure washer 4 and the fixing plate 3 can be utilized as a rotation torque, making it possible to hold the other member, for example, a cover member more securely.

FIG. 17 is an enlarged sectional view showing a fifth embodiment of the present invention. In this embodiment, the presser washer 4 is fitted between the two fixing plates 3, 3 of the first embodiment. Otherwise, this embodiment is the same as the first embodiment, so the same or like components are denoted by the same symbols and detailed description thereof is omitted. In this embodiment, the fixing plate 3 contacts both sides of the presser washer 4 so that an even greater friction force is generated between the presser washer 4 and each fixing plate 3, whereby the other member, for example, a cover member can be held more securely.

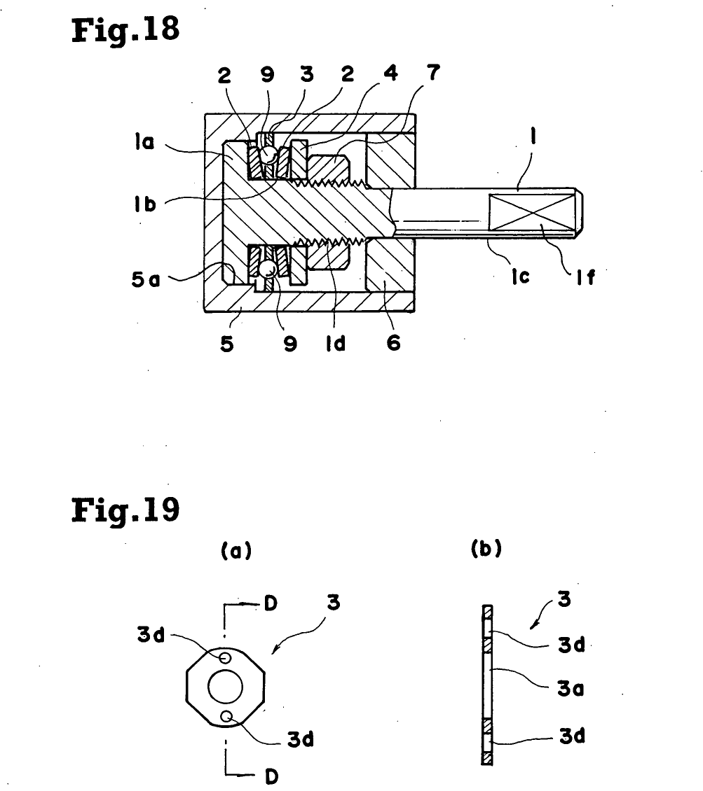

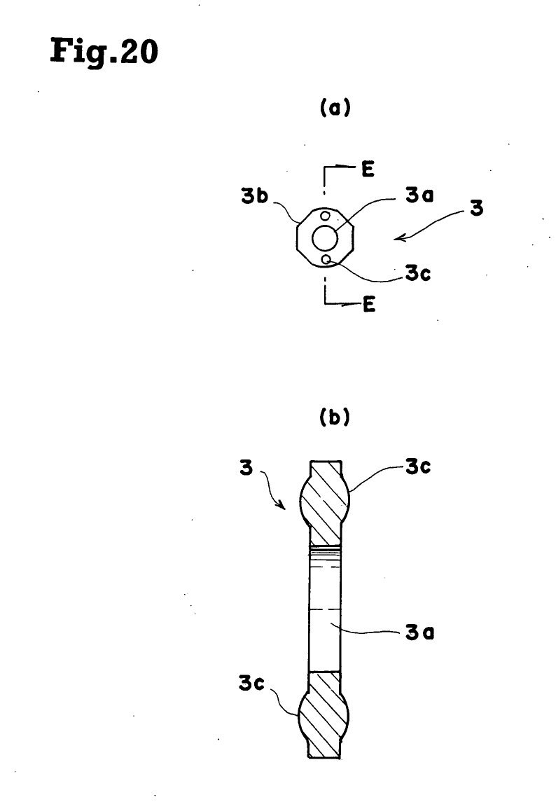

FIG. 18 is an enlarged sectional view showing a sixth embodiment of the present invention. In this embodiment, instead of the protrusions 3c of the fixing plate 3 of the first embodiment, holes 3d as shown in FIGS. 19(a) and 19(b) are provided at positions corresponding to the protrusions 3c, with balls 9 being embedded in the holes 3d. Otherwise, this embodiment is the same as the first embodiment. The balls 9 may be either stationary or rotatable.

The fixing plate 3 shown in FIG. 20 has the protrusions 3c that are integrally formed on both sides thereof. With the fixing plate 3 as shown in FIG. 20 and with the fixing plate 3 using the balls 9 as shown in FIG. 18, only one fixing plate 3 suffices in the construction of the first embodiment as shown in FIG. 2 and in the construction of the third embodiment as shown in FIG. 15.

Further, according to the present invention, the constructions of the spring washer 2 and the fixing plate 3 may be switched with each other. For example, in the first embodiment shown in FIG. 2, the following construction may be adopted. That is, the outer shape of the spring washer 2 is formed as a non-circular shape (hexagon) in conformity with the non-circular hole 5b of the case 5, with the center hole thereof being formed in a circular shape, thus allowing the spring washer 2 to freely rotate with respect to the main shaft portion 1b of the movable shaft 1; as for the fixing plate 3, its center hole is formed as a non-circular hole in conformity with the non-circular portion of the main shaft portion 1b of the movable shaft 1, and its outer shape is circular, thus allowing the fixing plate 3 to freely rotate with respect to the case 5. With this construction, too, the same functions as those attained in the first embodiment can be achieved. That is, although the spring washer 2 does not rotate, the fixing plate 3 is held in surface contact with the spring washer 2 and rotates together with the movable shaft 1, whereby in the rotation position where the protrusion 3c of the fixing plate 3 and the convex portion 2b of the spring washer 2 overlap each other, the spring washer 2 is compressed and its urging force increases, resulting in an increased rotation torque, whereas in the rotation position where the protrusion 3c of the fixing plate 3 and the convex portion 2b of the spring washer 2 are shifted from each other, the urging force of the spring washer 2 decreases, resulting in a reduced rotation torque.

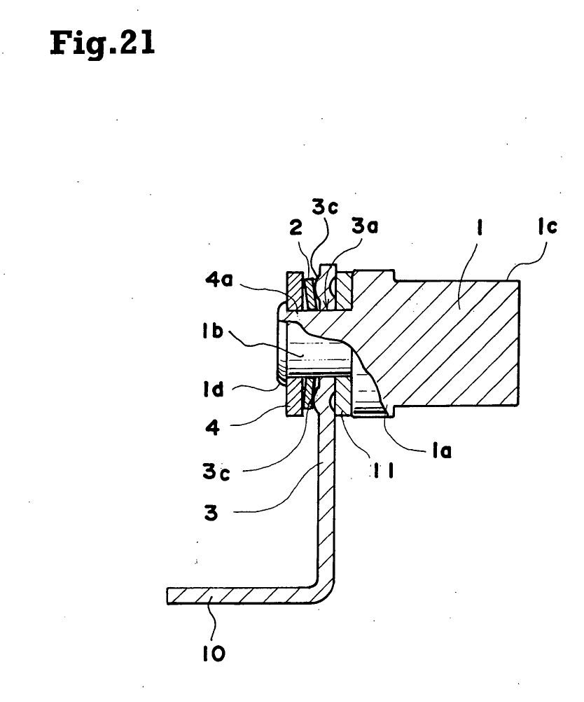

FIG. 21 is an enlarged sectional view showing a seventh embodiment of the present invention. In this embodiment, instead of the case 5 as described in the foregoing embodiments, a bracket 10 is used as the base member. The major feature of this embodiment resides in that a part of the bracket 10 also serves as the fixing plate 3.

That is, the bracket 10 is the one member, for example, a member to be fixed to the main body, with the movable shaft 1 being rotatably supported to the bracket 10. The movable shaft 1 is composed of the flange portion 1a, the main shaft portion 1b, and the support shaft portion 1c. A friction washer 11, the bracket 10, the spring washer 2, and the presser washer 4 are inserted onto the main shaft portion 1b. An end portion of the main shaft portion 1b is secured by caulking 1d to prevent dislodging, and presses the bracket 10 and the friction washer 11 through the intermediation of the spring washer 2. The main shaft portion 1b has a non-circular sectional configuration (e.g. W-D configuration). The friction washer 11, the spring washer 2, and the presser washer 4 are also provided with non-circular holes in conformity with the non-circular sectional configuration of the main shaft portion 1b; when inserted onto the main shaft portion 1b, those components are fitted on the main shaft portion 1b while having their rotation restricted and rotate together with the movable shaft 1. On the other hand, the bracket 10 has a circular hole, allowing the bracket 10 to freely rotate with respect to the movable shaft 1. The bracket 10 thus does not rotate even when the movable shaft 1 rotates.

Further, the protrusions 3c are provided in the contact surfaces of the bracket 10 with the spring washer 2, the bracket 10 thus serving as the fixing plate 3 described above.

Further, a portion of the support shaft portion 1c of the movable shaft 1 has a non-circular sectional configuration, and the other member, for example, a cover member, is fixed to this portion.

Accordingly, when the bracket 10 is fixed to the one member, and the other member is fixed to the support shaft portion 1c of the movable shaft 1, the movable shaft 1 rotates as the other member is opened and closed. As the movable shaft 1 rotates, the friction washer 11, the spring washer 2, and the presser washer 4 rotate together with the movable shaft 1, but the bracket 10 (including the fixing plate 3 portion) does not rotate. Accordingly, the spring washer 2 and the fixing plate 3 portion of the bracket 10, as well as the bracket 10 and the friction washer 11, are pressed into sliding surface contact with each other for relative rotation therebetween. As a result, in the rotation position where the convex portion 2b of the spring washer 2 overlaps the protrusion 3c of the bracket 10, the spring washer 2 is compressed, causing an increase in the urging force with which the spring washer 2 comes into contact with the protrusion 3c of the bracket 10, and thus a larger rotation torque results; conversely, in the rotation position where the convex portion 2b of the spring washer 2 and the protrusion 3c of the bracket 10 are shifted from each other, the urging force of the spring washer 2 decreases, and thus a smaller rotation torque results. Such changes in the rotation torque make it possible to control the opening and closing of the one member and the other member.

In addition, as the friction washer 11 rotates, a friction torque (friction force) is generated in its contact surface with the bracket 10, making it possible to control the opening and closing of the one member and the other member also by this friction torque in addition to the above-described rotation torque.

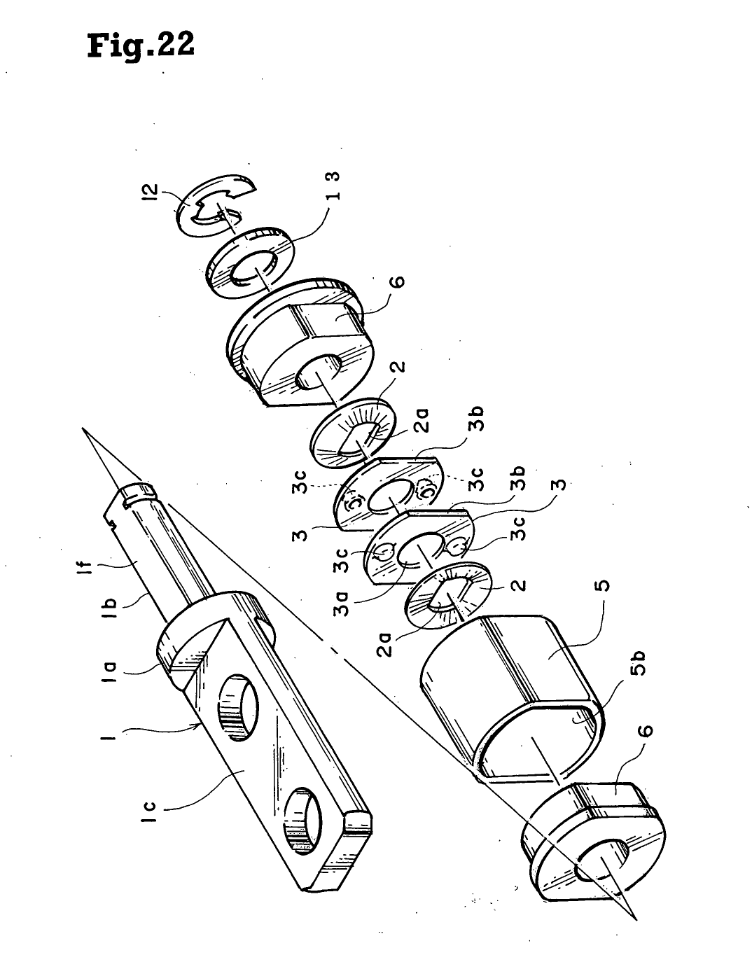

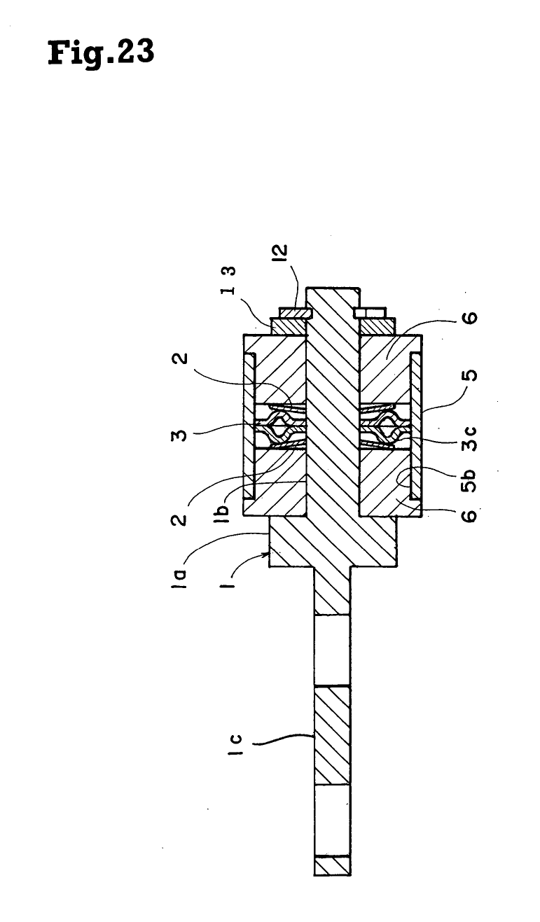

FIG. 22 is an enlarged, exploded perspective view showing an eighth embodiment of the present invention. FIG. 23 is an enlarged sectional view showing the eighth embodiment of the present invention. According to this embodiment, in the construction of the first embodiment, the movable shaft 1 penetrates through the case 5 that is the base member. That is, the movable shaft 1 has the flange portion 1a provided at a substantially axially intermediate portion thereof, with the main shaft portion 1b extending on one side, and the support shaft portion 1c extending on the other side, of the flange portion 1a. The case 5 is a hollow cylinder that is open at both ends, and the inner portion of the hollow defines the non-circular hole 5b. The cover 6 is fitted over the opening of the case 5 at one end. The main shaft portion 1b of the movable shaft 1 is rotatably inserted into the case 5 from the cover 6 and penetrates through the case 5. The spring washer 2, the fixing plates 3, and the spring washer 2 are fitted onto the main shaft portion 1b of the movable shaft 1 in the stated order from the other opening of the case 5, with those components being held in contact with each other as they are pressed by the cover 6 closing the other opening. Two fixing plates 3 are arranged back to back so that the protrusions 3c face outwardly with respect to each other, with the spring washer 2 being oriented such that its convex portion 2b abuts the fixing plate 3. The forward end portion of the main portion 1b of the movable shaft 1 penetrates through the cover 6 closing the other opening. Dislodging of the cover 6 is prevented at this forward end portion by using an E-ring 12 fitted through the intermediation of a presser washer 13. This allows the spring washer 2 and the fixing plate 3 to be received within the case 5 while held in press contact with each other. Caulking may be used instead of the E-ring 12 to prevent dislodging of the cover 6.

In this embodiment as well, the spring washer 2 is provided with the non-circular hole 2a in conformity with the non-circular sectional configuration of the main shaft portion 1b of the movable shaft 1, whereby the spring washer 2 is non-rotatably but axially movably inserted onto the main shaft portion 1b of the movable shaft 1, and rotates together with the movable shaft 1. The fixing plate 3 is provided with the non-circular hole 3a rotatable with respect to the main shaft portion 1b of the movable shaft 1, and has a non-circular outer shape that is in conformity with the non-circular hole 5b defining the interior of the hollow of the case 5. Accordingly, the fixing plate 3 is rotatably and axially movably inserted onto the main shaft portion 1b of the movable shaft 1 while having its rotation restricted by the case 5, whereby the fixing plate 3 does not rotate even when the movable shaft 1 rotates but is capable of axial movement. Therefore, the spring washer 2 and the fixing plate 3 are pressed into contact with each other for relative rotation therebetween.

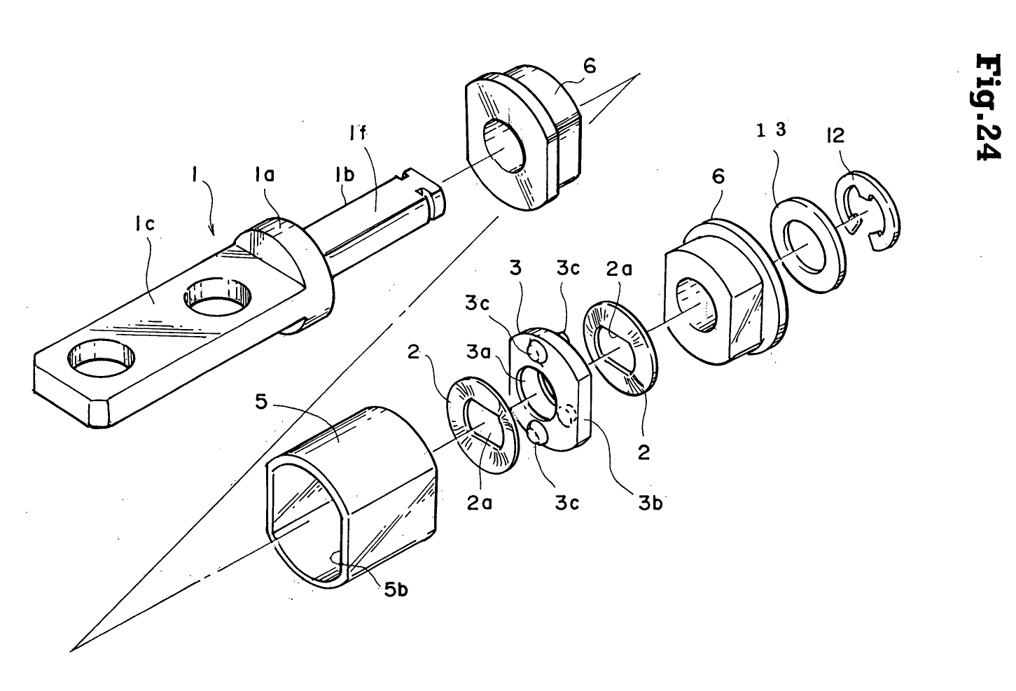

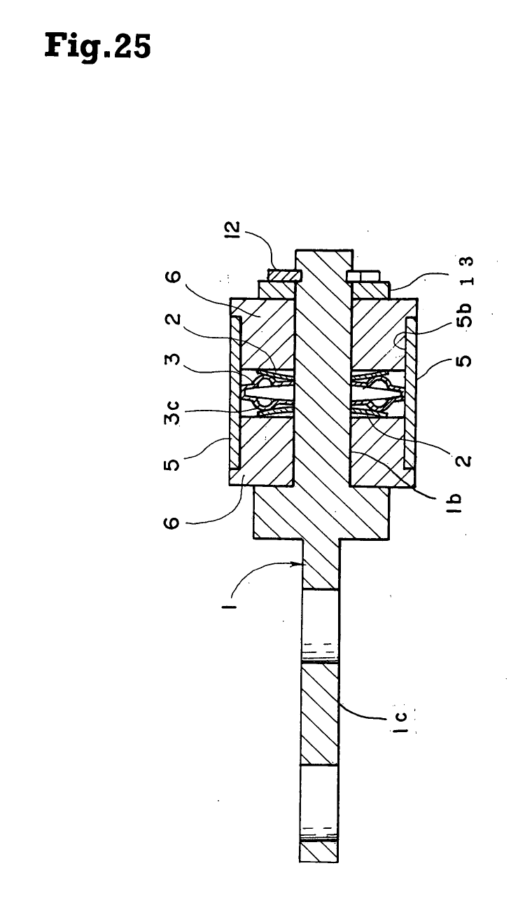

FIG. 24 is an enlarged, exploded perspective view showing a ninth embodiment of the present invention. FIG. 25 is an enlarged sectional view showing the ninth embodiment of the present invention. According to this embodiment, the two fixing plates 3, 3 of the above-described eighth embodiment, which are arranged back to back with their respective protrusions 3c facing outwardly with respect to each other, are integrated into one fixing plate 3. Otherwise, this embodiment is the same as the eighth embodiment, so the same or like components are denoted by the same symbols and detailed description thereof is omitted.

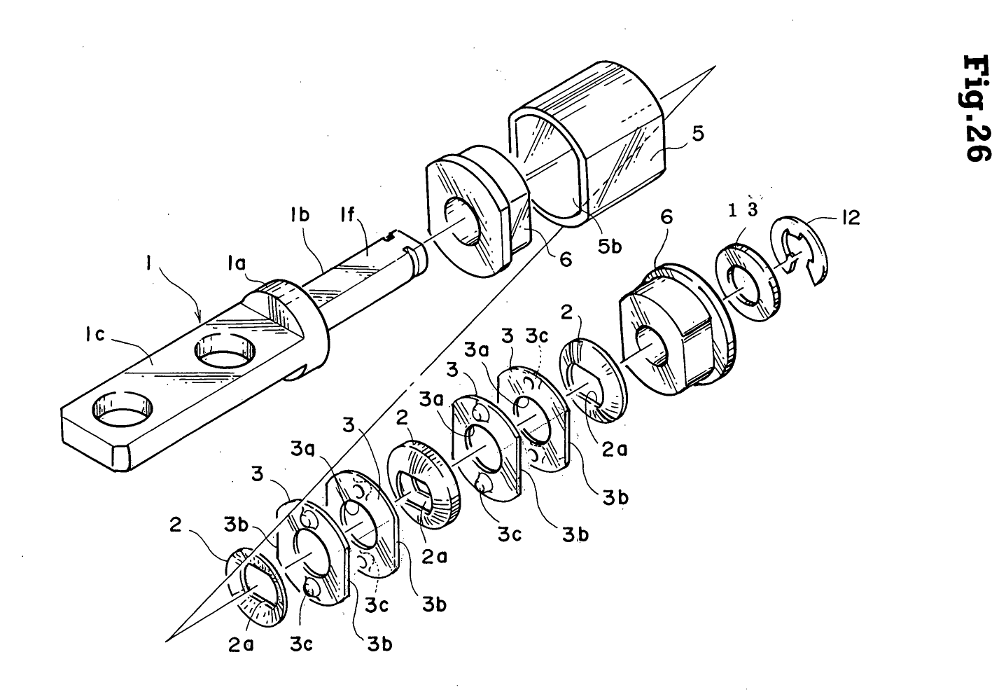

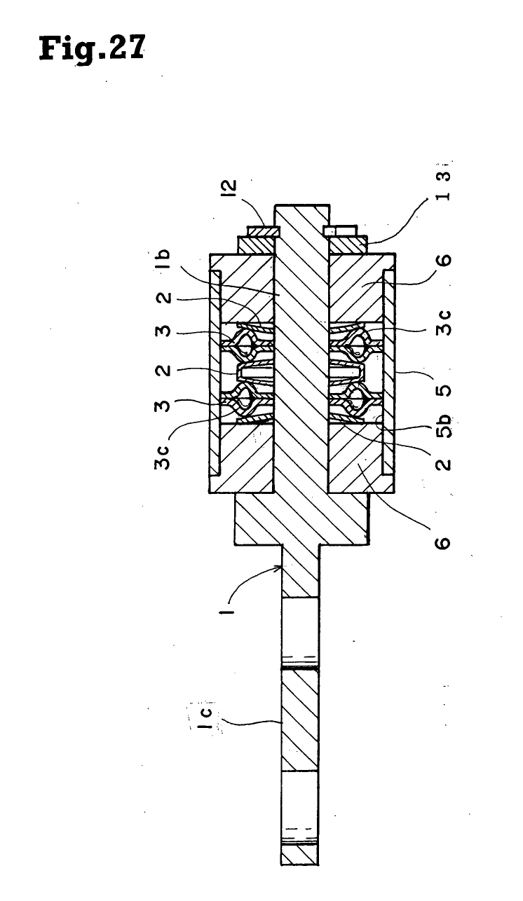

FIG. 26 is an enlarged, exploded perspective view showing a tenth embodiment of the present invention. FIG. 27 is an enlarged sectional view showing the tenth embodiment of the present invention. According to this embodiment, the combination of the spring washer 2 and the fixing plate 3 in the eighth embodiment is provided in multiple stages (multiple layers); the spring washer 2 located at the center consists of two integrated spring washers 2, 2 to be arranged back to back such that their convex portions 2b abut the fixing plate 3. Otherwise, this embodiment is the same as the eighth embodiment, so the same or like components are denoted by the same symbols and detailed description thereof is omitted. An even larger rotation torque can be generated according to this embodiment. Further, since the spring washer 2 and the fixing plate 3 each consist of a plate member, the multi-staged (multi-layered) construction does not result in a large increase in longitudinal (axial) size.

With the embodiments as shown in FIGS. 22 through 27, in particular, the mechanism portions such as the spring washer 2 and the fixing plate 3 are received within the case 5, thus achieving a compact construction while protecting those components without exposing them to the exterior. Also, the movable shaft 1 penetrates through the case 5, thereby facilitating assembly.

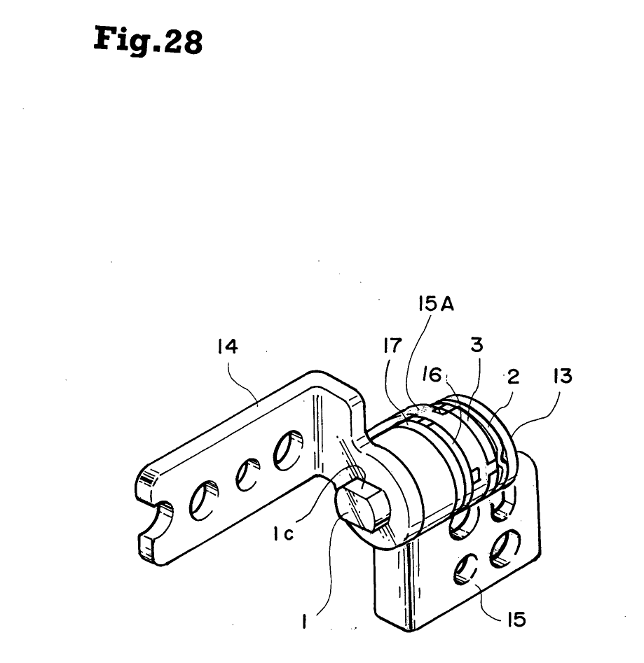

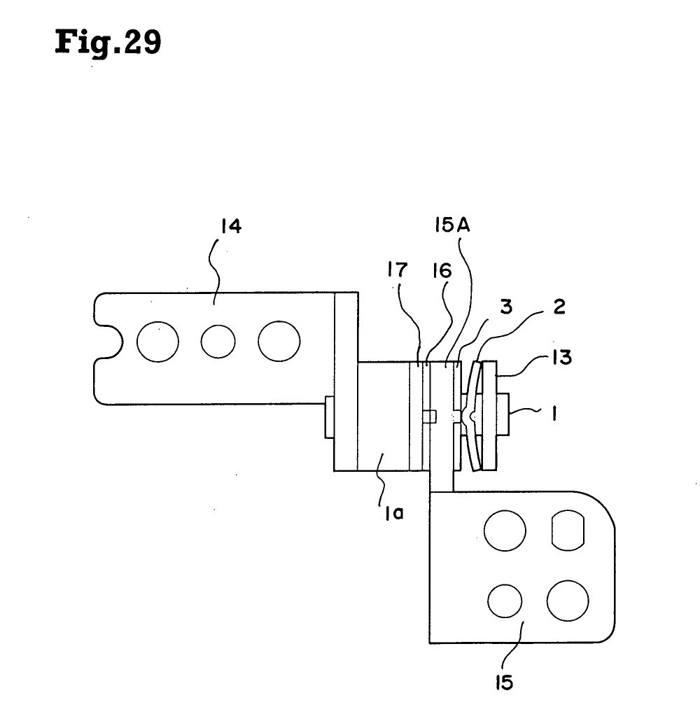

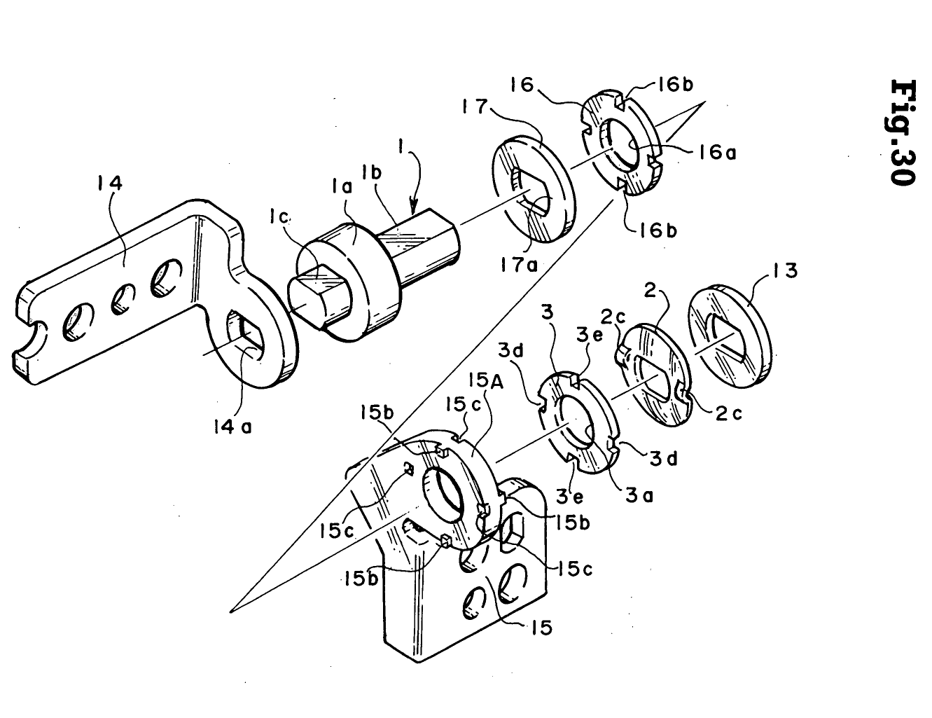

FIG. 28 is an enlarged perspective view showing an eleventh embodiment of the present invention, FIG. 29 is an enlarged front view showing the eleventh embodiment of the present invention, and FIG. 30 is an enlarged, exploded perspective view showing the eleventh embodiment of the present invention. According to this embodiment, there are provided a first bracket 14 and a second bracket 15, and mounting of the assembly to one member and the other member is effected with the brackets 14, 15. Specifically, the movable shaft 1 has the flange portion 1a provided midway through its axial length; with the flange portion 1a as the center, the main shaft portion 1b is provided on one side and the support shaft portion 1c is provided on the other side. The main shaft portion 1b and the support shaft portion 1c each have a non-circular sectional configuration, for example, a W-D configuration.

The first bracket 14 has a non-circular hole 14a that is in conformity with the non-circular sectional configuration of the support shaft portion 1c of the movable shaft 1. The first bracket 14 is non-rotatably secured in position by inserting the non-circular hole 14a onto the support shaft portion 1c, with the end portion of the support shaft portion 1c being caulked to prevent dislodging. A friction washer 17 as a friction plate, a reinforcing plate 16, the second bracket 15, the fixing plate 3, and the spring washer 2 as a leaf spring member, are fitted in the stated order onto the main shaft portion 1b of the movable shaft 1, and the end portion of the main shaft portion 1b is caulked to prevent dislodging, with those components being pressed and held in contact with each other by the presser washer 13. The means for preventing dislodging is not limited to caulking; other means, such as an E-ring, may also be employed.

The friction washer 17, which has a non-circular hole 17a in conformity with the main shaft portion 1b, is non-rotatably but axially movably inserted onto the main shaft portion 1b. The reinforcing plate 16 and the fixing plate 3 have circular holes 16a and 3a, respectively, and are rotatably and axially movably inserted onto the main shaft portion 1b. As shown in FIG. 31, the second bracket 15 has a circular hole 15a and is rotatably and axially movably inserted onto the main shaft portion 1b. The spring washer 2, which has the non-circular hole 2a in conformity with the main shaft portion 1b, is non-rotatably but axially movably inserted onto the main shaft portion 1b.

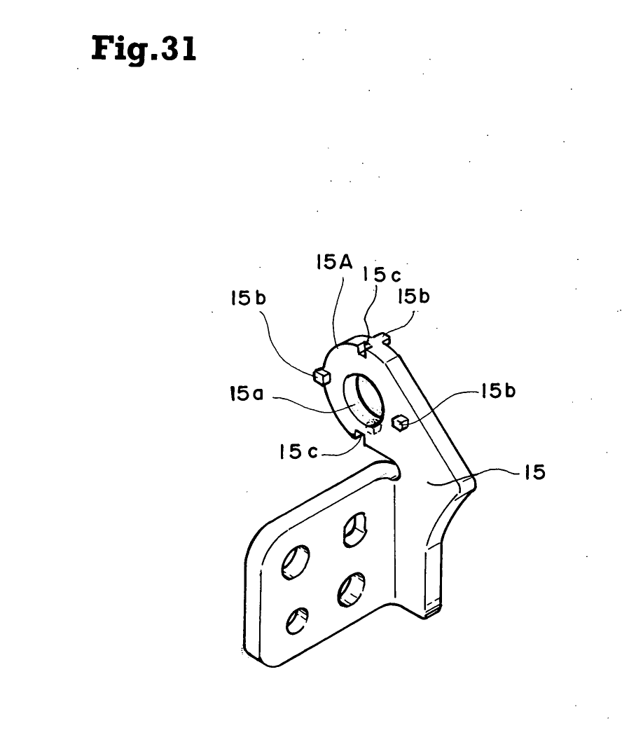

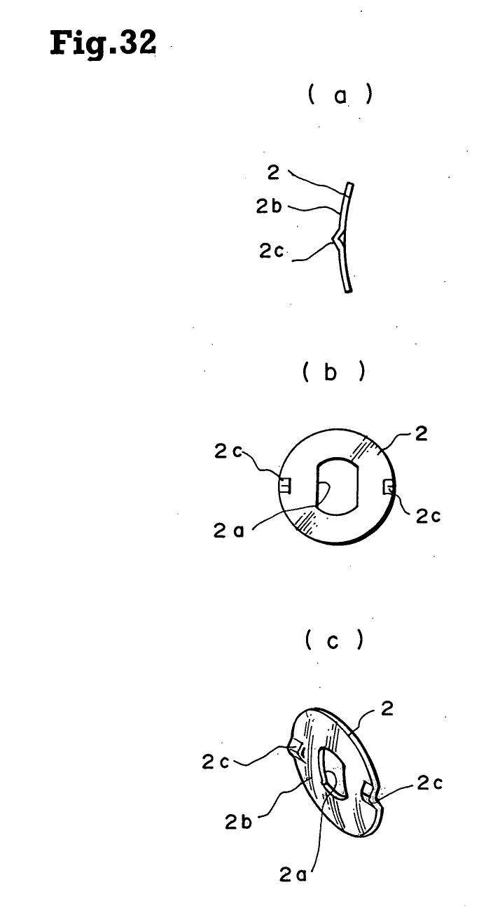

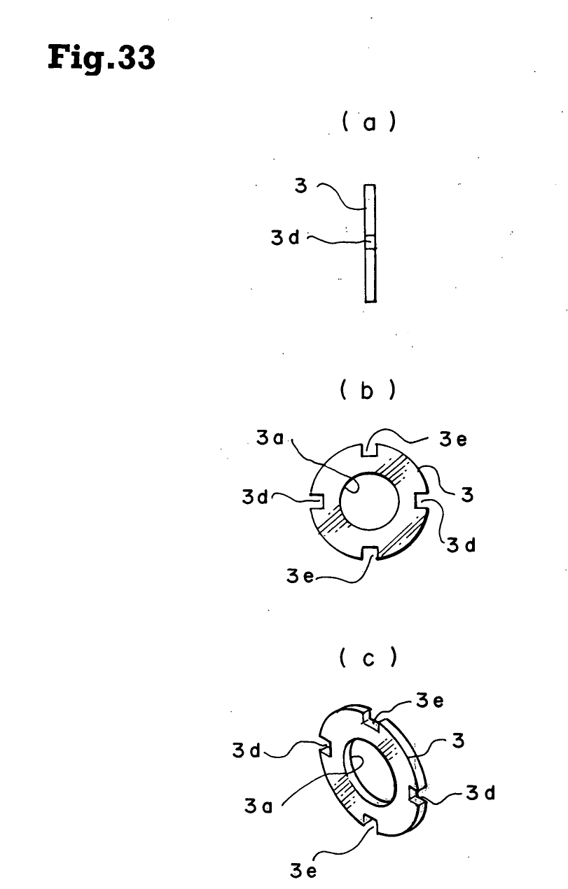

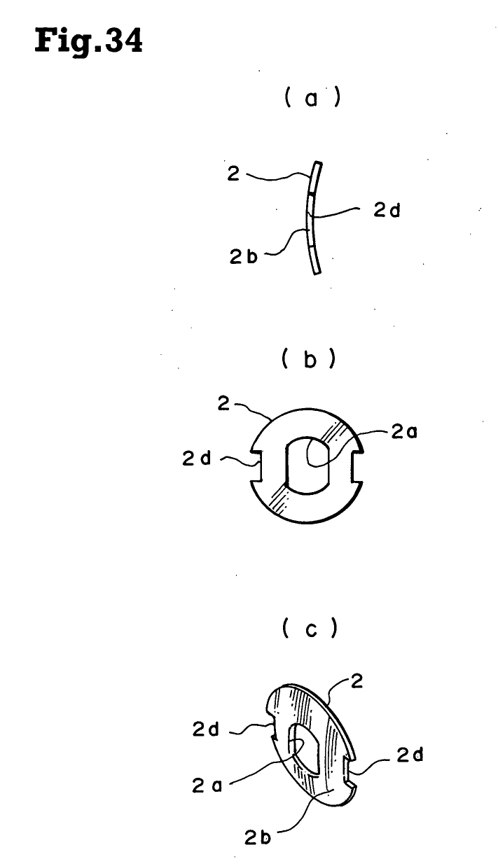

As shown in FIG. 32, the spring washer 2 of this embodiment has protrusions 2c. Further, as shown in FIG. 33, the fixing plate 3 has cutouts 3e, into which the protrusions 2c of the spring washer 2 fall when the fixing plate 3 rotates while in surface contact with the spring washer 2, and cutouts 3d described later that are to be attached onto the second bracket 15.

That is, a mounting portion 15A of the second bracket 15 to the movable shaft 1 has protrusions 15b respectively provided in its contact surfaces with the reinforcing plate 16 and the fixing plate 3. The reinforcing plate 16 and the fixing plate 3 have cutouts 16b and 3d, respectively, provided at positions which correspond to the protrusions 15b when the reinforcing plate 16 and the fixing plate 3 are inserted onto the main shaft portion 1b of the movable shaft 1. The reinforcing plate 16 and the fixing plate 3 are secured onto the mounting portion 15A of the second bracket 15 as the protrusions 15b of the second bracket 15 are fitted into the cutouts 16b and 3d. As a result, the reinforcing plate 16 and the fixing plate 3 operate in synchronism with the second bracket 15. The above-mentioned combination of the protrusions 15b and the cutouts 16b and 3b may be such that the protrusions are provided to the reinforcing plate 16 and the fixing plate 3, with the cutouts being provided in the second bracket 15.

Meanwhile, when the first bracket 14 is mounted to one member, for example, a cover member, and the second bracket 15 is mounted to the other member, for example, a main body, as the cover member is opened and closed with respect to the main body, the movable shaft 1 rotates with respect to the main body (the second bracket 15), causing the friction washer 17, the spring washer 2, and the presser washer 13 to also rotate together with this rotation. The second bracket 15, the fixing plate 3, and the reinforcing plate 16 do not rotate at this time. Since the spring washer 2 and the fixing plate 3, as well as the reinforcing plate 16 and the friction washer 17, are pressed into surface contact with each other, the above rotation causes the spring washer 2 and the friction washer 17 to rotate while in surface contact with the fixing plate 3 and the reinforcing plate 16, respectively. Accordingly, the spring washer 2 contracts or expands as the protrusions 2c of the spring washer fall into or ride over the cutouts 3e, causing a change in contact force, whereby the generated rotation torque also changes. Further, a clicking sensation is produced at the time when the protrusions 2c fall into the cutouts 3e. Further, a friction force is generated between the friction washer 17 and the reinforcing plate 16. The friction force thus generated can be used in addition to the rotation torque in controlling the opening and closing operations.

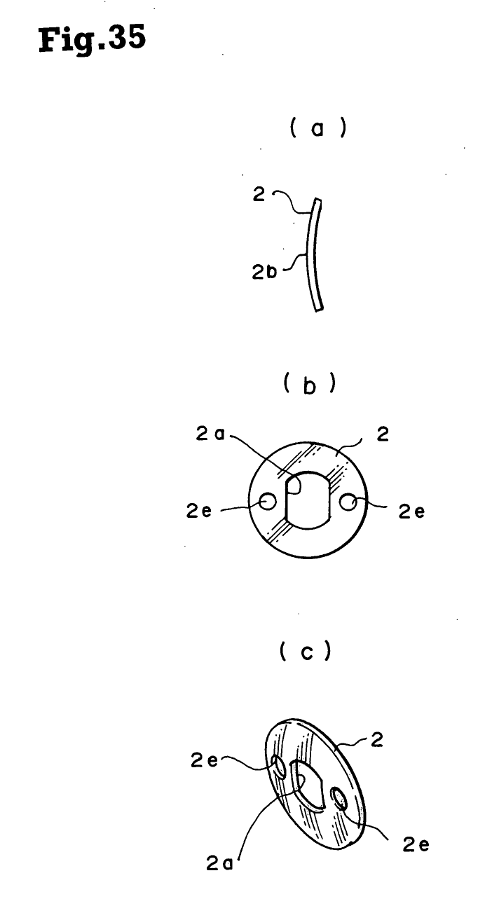

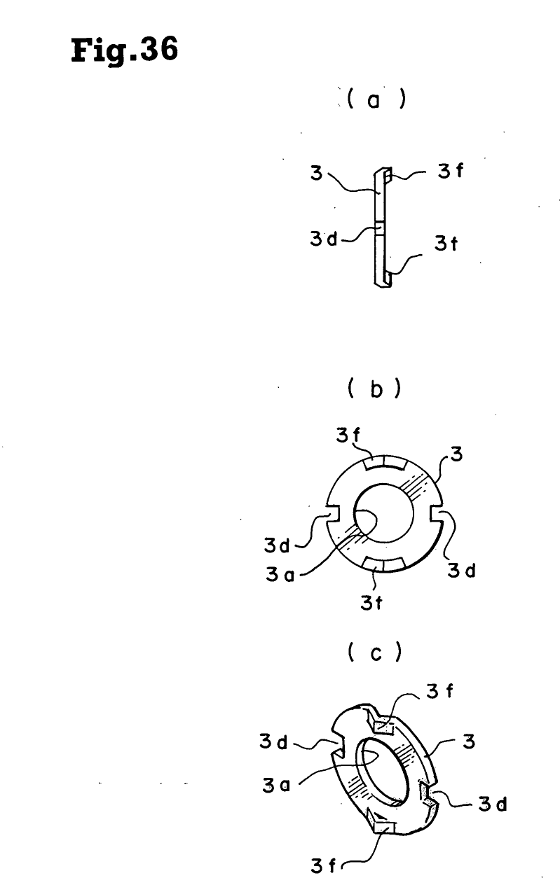

FIGS. 34 and 35 each show a modification of the spring washer 2. FIG. 34 shows the spring washer 2 having cutouts 2d, and FIG. 35 shows the same having holes 2e. FIG. 36 shows a modification of the fixing plate 3, illustrating the fixing plate 3 having projecting portions 3f in addition to the cutout 3d. A rotation torque different from that of the eleventh embodiment can be attained by modifying the spring washer 2 and the fixing plate 3 into the spring washer 2 as shown in FIG. 34 or 35 and the fixing plate 3 as shown in FIG. 36, respectively. This may be achieved by changing the configurations of the spring washer 2 and fixing plate 3 as appropriate according to the rotation torque characteristics required.

It is to be noted that the construction for producing a clicking sensation according to this embodiment may be employed for the first through tenth embodiments as well.

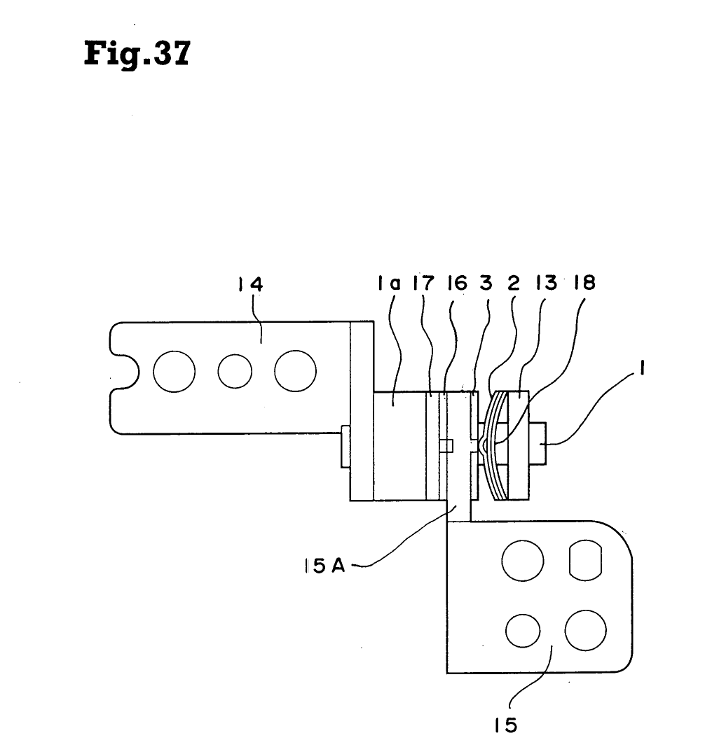

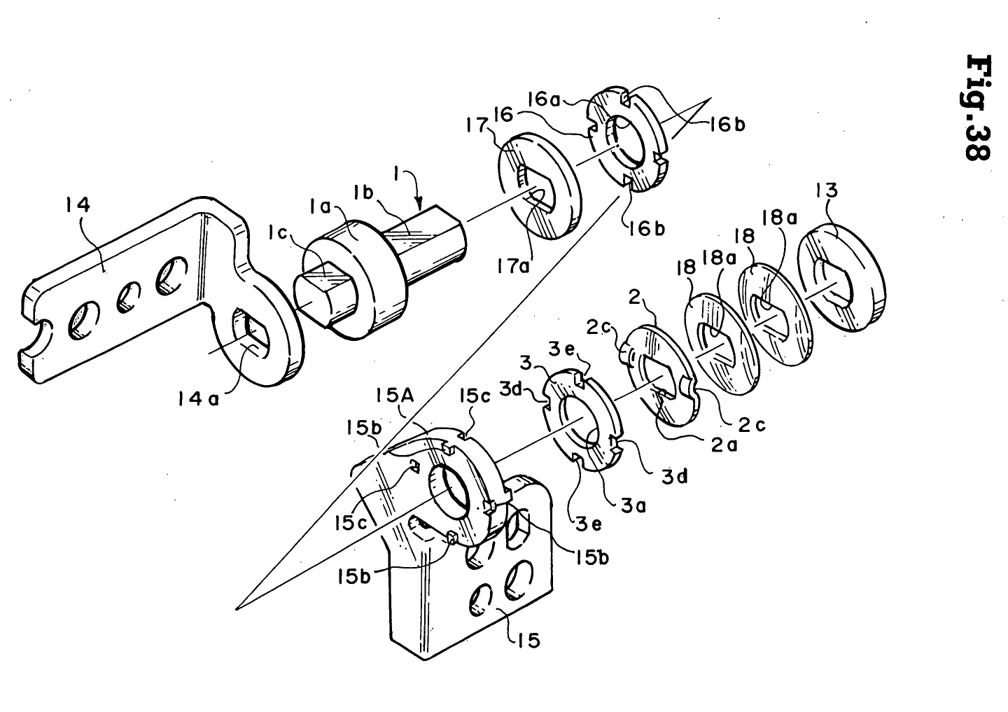

FIG. 37 is an enlarged front view showing a twelfth embodiment of the present invention, and FIG. 38 is an enlarged, exploded perspective view showing the twelfth embodiment of the present invention. According to this embodiment, reinforcing spring washers 18 as reinforcing leaf spring members are laminated on the spring washer (leaf spring member) 2 of the eleventh embodiment. Otherwise, this embodiment is the same as the eleventh embodiment, so the same or like components are denoted by the same symbols and detailed description thereof is omitted. Since this construction allows the rotation torque to be changed by changing the number of the reinforcing spring washers 18 to be laminated, the number of the reinforcing spring washers 18 is to be set according to the requisite torque. This embodiment illustrates a case where two reinforcing spring washers 18 are laminated.

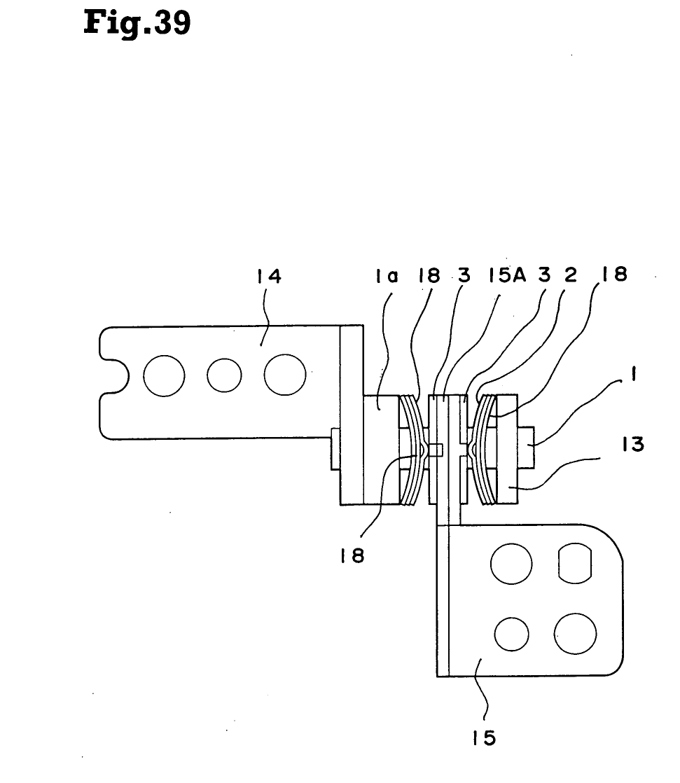

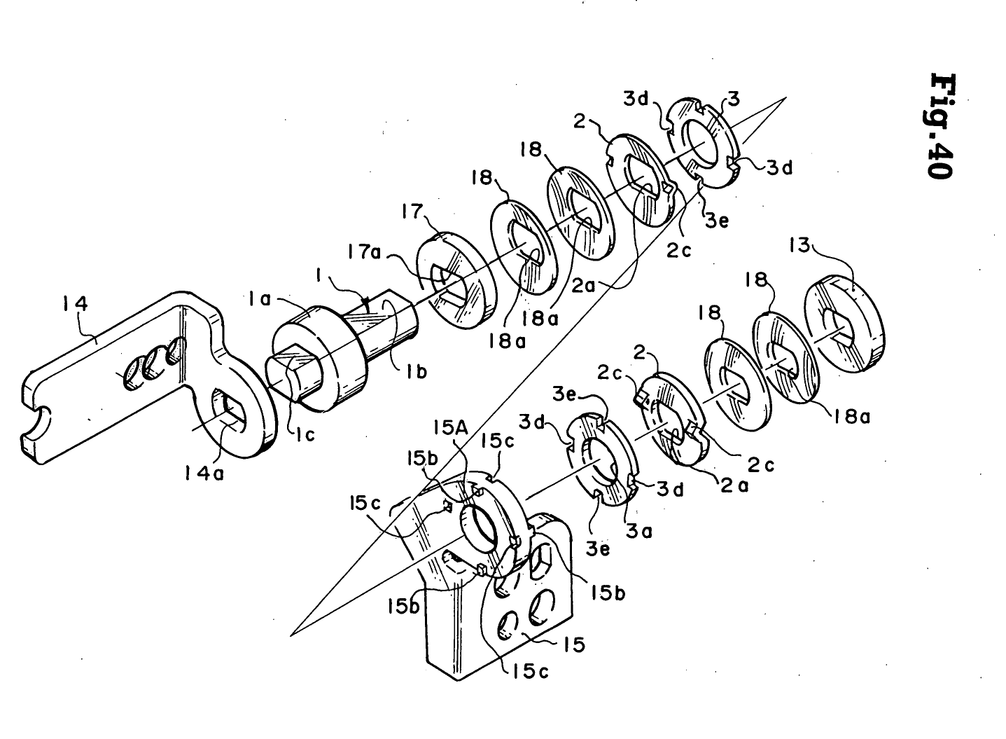

FIG. 39 is an enlarged front view showing a thirteenth embodiment of the present invention, and FIG. 40 is an enlarged, exploded perspective view showing the thirteenth embodiment of the present invention. In this embodiment, the reinforcing spring washer 18 assembly as shown in the twelfth embodiment is provided on either side of the second bracket 15, with the same or like components being denoted by the same symbols. This embodiment, which enables a rotation torque to be controlled on either side of the second bracket 15, is optimum when applied to devices requiring a large rotation torque.

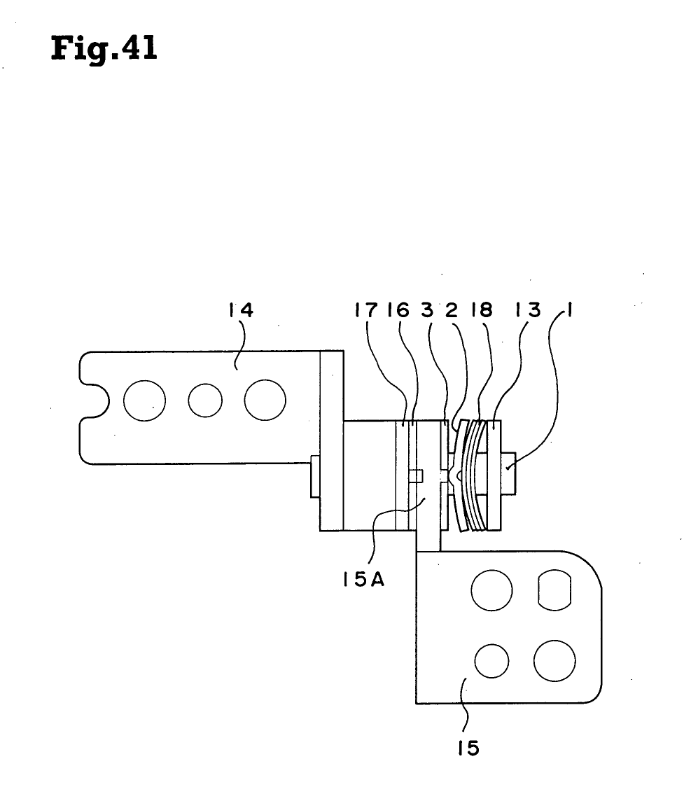

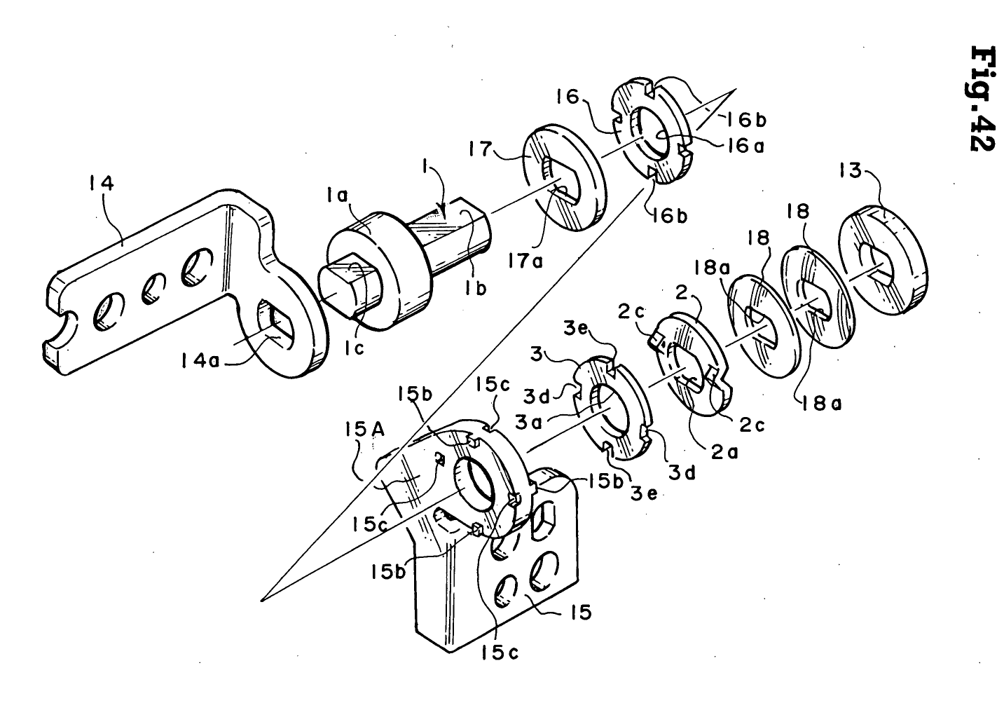

FIG. 41 is an enlarged front view showing a fourteenth embodiment of the present invention, and FIG. 42 is an enlarged, exploded perspective view showing the fourteenth embodiment of the present invention.

According to this embodiment, in the construction of the twelfth embodiment (FIGS. 37, 38), the thickness of the spring washer (leaf spring member) 2 is increased; otherwise, this embodiment is the same as the twelfth embodiment. With this embodiment, the spring washer 2 and the reinforcing spring washer 18 differ in spring force and deflection amount, whereby they may be used as appropriate to serve different purposes such that the reinforcing spring washer 18 is used for portions where deflection is required and the spring washer 2 is used for portions where a torque is required. It is to be noted that an increase in the thickness of the spring washer 2 as in this embodiment allows enhanced strength of the protrusions 2c, thus achieving improved reliability.

### INDUSTRIAL APPLICABILITY

As described in the foregoing, the hinge device according to the present invention is suitable for use as a hinge device for openably and closably connecting one member and the other member. The hinge device proves particularly effective when used as: a hinge device for openably and closably connecting a main body and a cover member in small OA devices or portable terminal devices such as a notebook PC and a portable telephone; a hinge device for openably and closably connecting a toilet main body with a toilet seat or a lid member; and the like.

1. A hinge device for openably and closably connecting one member and the other member, comprising: a base member fixed to the one member; a movable shaft that is rotatably supported by the base member and to which the other member is fixed; a leaf spring member having a curved portion and non-rotatably but axially movably inserted onto the movable shaft; and a fixing plate inserted onto the movable shaft such that the fixing plate does not rotate when the movable shaft rotates but is axially movable, the fixing plate having at least two protrusions provided on its surface in contact with the leaf spring member, characterized in that the leaf spring member and the fixing plate are pressed into contact with each other for relative rotation therebetween.

2. A hinge device for openably and closably connecting one member and the other member, comprising: a base member fixed to the one member; a movable shaft that is rotatably supported by the base member and to which the other member is fixed; a leaf spring member having a curved portion and inserted onto the movable shaft such that the leaf spring member does not rotate when the movable shaft rotates but is axially movable; and a fixing plate non-rotatably but axially movably inserted onto the movable shaft, the fixing plate having at least two protrusions provided on its surface in contact with the leaf spring member, characterized in that the fixing plate and the leaf spring member are pressed into contact with each other for relative rotation therebetween.

3. A hinge device according to claim 1, characterized in that the base member is a bottomed hollow cylindrical case, and that the movable shaft onto which the leaf spring member and the fixing plate are inserted is rotatably supported by the case, with the leaf spring member and the fixing plate being received within the case.

4. A hinge device according to claim 1, characterized in that the base member is a hollow cylindrical case that is open at both ends, and that the movable shaft onto which the leaf spring member and the fixing plate are inserted is rotatably supported while penetrating through the case, with the leaf spring member and the fixing plate being received within the case.

5. A hinge device according to claim 1, characterized in that one of the leaf spring member and the fixing plate is provided with a protrusion and the other is provided with a recess, hole, or cutout into which the protrusion falls, and that a clicking sensation is produced when the protrusion provided in the one of the leaf spring member and the fixing plate fits in the recess, hole, or cutout provided in the other as the leaf spring member and the fixing plate relatively rotate while in press contact with each other.

6. A hinge device for openably and closably connecting one member and the other member, comprising: a bracket fixed to the one member; a movable shaft that is rotatably supported by the bracket and to which the other member is fixed; and a leaf spring member having a curved portion and non-rotatably but axially movably inserted onto the movable shaft, characterized in that the bracket has at least two protrusions provided on its surface in contact with the leaf spring member, and that the leaf spring member and the bracket are pressed into contact with each other for relative rotation therebetween.

7. A hinge device according to claim 6, characterized in that one of the leaf spring member and the bracket is provided with a protrusion and the other is provided with a recess, hole, or cutout into which the protrusion falls, and that a clicking sensation is produced when the protrusion provided in the one of the leaf spring member and the bracket fits in the recess, hole, or cutout provided in the other as the leaf spring member and the bracket relatively rotate while in press contact with each other.

8. A hinge device for openably and closably connecting one member and the other member, comprising: a movable shaft; a first bracket non-rotatably and fixedly installed on the movable shaft and fixed to the one member; a second bracket rotatably and axially movably inserted onto the movable shaft and fixed to the other member; a fixing plate secured onto the second bracket while having the movable shaft inserted through the fixing plate; and a leaf spring member having a curved portion and non-rotatably but axially movably inserted onto the movable shaft, characterized in that at least two protrusions are provided on a contact surface of one of the fixing plate and the leaf spring member, and that the fixing plate and the leaf spring member are pressed into contact with each other for relative rotation therebetween.

9. A hinge device according to claim 8, characterized in that one of the leaf spring member and the fixing plate that is secured onto the second bracket is provided with a protrusion and the other is provided with a recess, hole, or cutout into which the protrusion falls, and that a clicking sensation is produced when the protrusion provided in the one of the leaf spring member and the fixing plate fits in the recess, hole, or cutout provided in the other as the leaf spring member and the fixing plate relatively rotate while in press contact with each other.

10. A hinge device according to claim 8, characterized in that: the movable shaft has a flange portion provided at a midway position thereof; a friction plate is non-rotatably but axially movably inserted onto the movable shaft while in contact with the flange portion of the movable shaft; a reinforcing plate is secured, while being inserted onto the movable shaft, onto a side surface of the second bracket which is opposite to a side surface onto which the fixing plate is secured; and the friction plate and the reinforcing plate are pressed into contact with each other for relative rotation therebetween.

11. A hinge device according to claim 1, characterized in that a reinforcing leaf spring member is laminated on the leaf spring member.

12. A hinge device according to claim 11, characterized in that the leaf spring member and the reinforcing leaf spring member laminated on each other differ in spring force.

13. A hinge device according to claim 11, characterized in that the leaf spring member and the reinforcing leaf spring member laminated on each other differ in deflection amount.

14. A hinge device according to claim 1, characterized in that the protrusion is a ball.
